(19) United States
(12) Patent Application Publication
(10) Pub. No.: US 2011/0015066 A1
(43) Pub. Date: Jan. 20, 2011

(54) Herbicidal Composition

(76) Inventors: Jaidev Rajnikant Shroff, Mumbai (IN); Vikram Rajnikant Shroff, Mumbai (IN); Ajit Kumar, Mumbai (IN)

Correspondence Address: Yancy IP Law, PLLC, 5904 Jane Way, Alexandria, VA, 22310, US

(21) Appl. No.: 12/863,235

(22) PCT Filed: Jan. 21, 2009
(86) PCT No.: PCT/IN09/00054

§ 371 Date: Jul. 16, 2010

(30) Foreign Application Priority Data
Jan. 22, 2008 (IN) 153/MUM/2008

(51) Int. Cl. A01N 43/66; A01N 25/32; A01P 13/00

(52) U.S. Cl. 504/105; 504/134; 504/103

(57) ABSTRACT

A herbicidal composition comprising a first active ingredient being clodinafop-propargyl and a second active ingredient being metsulfuron methyl, wherein said metsulfuron methyl is provided in a particulate form having a substantially homogenous coating of hydrophobic inert material provided thereon and processes for the preparation thereof.

### FIELD OF THE INVENTION

The present invention relates generally to herbicidal compositions. More particularly, the present invention relates to an herbicidal composition that enables a simultaneous reduction of grassy and broadleaf weed population in a crop field.

### BACKGROUND OF THE INVENTION

An herbicide is used to kill unwanted plant weeds in a crop field. A primary consideration for a substance to be used as an herbicide requires the substance to be selective in killing specific targets while being capable of leaving the desired crop unharmed. Many modern chemical herbicides for agriculture are specifically formulated to decompose within a short period after application. This is desirable as it allows crops which may be affected by the herbicide to be grown on the land in future seasons. However, it has been seen that herbicides with low residual activity i.e. those which decompose quickly often do not provide season-long weed control. Therefore, there is a continuous need in the art to provide agricultural compositions that decompose within a predetermined time after application to the crop field but at the same time are stable enough to possess an appreciable efficacy in removing unwanted weeds.

U.S. Pat. No. 4,713,109 teaches a 2-propynyl ester of the compound 2-(4-(3-Chloro-5-fluoro-2-pyridyloxy)-phenoxy-propionic acid, which is commonly known as clodinafop-propargyl, a compound possessing demonstrated herbicidal activity specially in cereals, rice, wheat and soybeans crops. It is a member of the oxy phenoxy acid ester class of herbicides. It is known that clodinafop propargyl interacts with and inhibits the acetyl co-enzyme A carboxylase, which is essential for the production of lipids (fatty acids) needed for plant growth. The selectivity of this herbicide is based on the difference in the speed of herbicide breakdown in the crop versus the weeds. Clodinafop-propargyl converts from the ester form to the active acid and then to biologically inactive compounds. Grass weeds such as wild oats and wild millet cannot effectively break down clodinafop-propargyl, so they are controlled as a lethal dose accumulates at the meristematic growing points. This herbicide is known to control grasses such as green foxtail, barnyard grass, Persian darnel and volunteer canary seed in wheat crops. However, it is known that clodinafop propargyl is ineffective against several broadleaved weeds.

U.S. Pat. No. 4,881,966 teaches a composition comprising clodinafop-propargyl and a safener, which is cloquintocet-mexyl that accelerates the rate of clodinafop-propargyl break down in wheat, thus preventing the accumulation of a lethal dose. However, the disclosed composition is still not effective in controlling the growth of the broadleaved weeds.

Metsulfuron methyl, having the chemical formula methyl 2-(4-methoxy-6-methyl-1,3,5-triazin-2-ylcarbamoylsulfamoyl)benzoate is a pre and post emergence herbicide commonly used in forestry and vegetation management. It is a selective systemic herbicide absorbed through the roots and foliage, with rapid translocation both acropetally and basipetally. Susceptible plants cease growth almost immediately after post-emergence treatment and are killed in 7-21 days. It is known that surfactants increase the activity of metsulfuron-methyl selectively to certain broadleaved weeds to which clodinafop-propargyl is generally ineffective.

U.S. Pat. No. 6,479,432 discloses a liquid composition comprising a first active ingredient selected from sulfonylureas in combination with an additional active ingredient. The sulfonylurea may be metsulfuron methyl whereas the disclosed list of additional active ingredients includes clodinafop-propargyl among a plurality of other herbicidal active agents. However, this U.S. patent does not enable a composition comprising metsulfuron methyl and clodinafop propargyl as these two herbicides are per se found incompatible with each other. In fact it is conventionally known that a tank mix spray of metsulfuron with clodinafop results in antagonism thereby significantly reducing the efficacy of these grass herbicides.

Antagonism is defined as the interference in or inhibition of the physiological action of a chemical substance by another. An article in Planta Daninha. Vol. 25, No. 4, 839-847, 117/07-08 entitled “Antagonism of associations of clodinafop-propargyl with metsulfuron-methyl & 2,4-D in the control of Italian Ryegrass (lolium multiflorum” teaches that the association of clodinafop-propargyl with metsulfuron methyl reduces the control of Italian ryegrass by 28% as compared with clodinafop-propargyl used alone. Yet another reference by Kunz et al (2004) verified antagonism between clodinafop-propargyl and metsulfuron-methyl in sequential (successive) application for control of Avena sativa. The antagonism is suggested to occur by a reduction in absorption and/or translocation of the grass herbicides by the muti-foliage cultures. Also there is a possibility of reduction of metabolic activities such as cellular division and supply of lipids for the formation of a membrane which compromises the activity of ACCase inhibitors (Clodinafop propargyl).

It was further found that in compositions comprising clodinafop-propargyl and metsulfuron methyl, the latter active ingredient was found to be very unstable aggravated by the presence of the former. Numerous attempts have been made in the art to provide a composition including a combination of the two active ingredients but all these attempts have been largely unsuccessful not only because of the antagonism existing between the two compounds but also because of incompatibilities between Clodinafop propargyl and Metsulfuron methyl active ingredients.

Clodinafop-propargyl is known to be stable in acidic environment whereas metsulfuron methyl is known to be stable in neutral to alkaline pH conditions. It was found that the presence of clodinafop-propargyl destroys the relative smaller amount of metsulfuron methyl, which mechanism is generally believed to aggravate the incompatibility between the two active ingredients in combination. There were also strong antagonistic effects of metsulfuron on the performance of clodinafop resulting in tremendous reduction of efficacy of clodinafop. However, a compatible composition comprising clodinafop-propargyl and metsulfuron methyl has been desirable as they display complementary benefits of reducing grass weeds and broadleaved weeds respectively, but hitherto not been made possible.

Further, the sequential spraying of Clodinafop-propargyl and metsulfuron methyl is costly and time consuming. Generally, the resources required for the purpose of spraying include sprayer tank, spaying equipment, labour, cleaning agent etc. Proper cleaning and sanitization of sprayer tank and spraying equipment is essential in order to avoid contamination. The sequential spraying repeats the whole procedure of field treatment which is not economically feasible.

The sequential spraying of Clodinafop-propargyl and metsulfuron methyl is also not feasible from the point of view of safety of the farmers. In this the farmers are exposed to hazardous actives repeatedly which can be avoided by applying the composition comprising combination of actives. The sequential spraying also increases the environmental load of herbicides and hence not environmentally safe.

Thus, there exists a need within the art for a composition comprising clodinafop-propargyl and metsulfuron methyl having an enhanced compatibility between the two active ingredients and which shows superior and desirable weed control benefits.

### OBJECTS OF THE INVENTION

Accordingly, it is an object of the present invention to provide a herbicidal composition comprising clodinafop-propargyl and metsulfuron methyl having an enhanced compatibility between the two ingredients such that the stability of metsulfuron methyl is not compromised owing to the presence of clodinafop-propargyl.

Another object of the present invention is to provide an agrochemical particles comprising Metsulfuron methyl particles substantially homogenously coated with hydrophobic inert material.

Another object of the present invention is to provide a composition comprising clodinafop-propargyl and metsulfuron methyl wherein each active ingredient displays an improved herbicidal activity in controlling the growth of grassy and broad leaf weeds in crops.

Another object of the present invention is to provide a herbicidal composition that enables a simultaneous control of grassy and broadleaf weed population in a crop field.

Yet another object of the present invention is to provide a herbicidal composition that affords an increased grain yield at a predetermined dosage of the composition to the crop field.

Another object of the present invention is to provide a herbicidal composition that enhances performance of weed control thereby reducing the required application frequency of the composition to control the grassy and broadleaved weeds in a crop field.

Another object of the present invention is to provide a herbicidal composition which demonstrates a complementation of weed control activity over the application of individual herbicides separately.

Yet another advantage of the present invention is to provide a metsulfuron methyl particulate form having a better stability and hence a better activity.

### SUMMARY OF THE INVENTION

Accordingly, in one aspect, the present invention provides an agrochemical particles comprising Metsulfuron methyl particles substantially homogenously coated with hydrophobic inert material.

In another aspect, the present invention provides a process for the preparation of metsulfuron methyl particles comprising grinding provided metsulfuron methyl particles to a predetermined particle size and mixing said ground metsulfuron methyl particles in a predetermined quantity with a hydrophobic inert material to obtain homogenous hydrophobic coated particles of metsulfuron methyl.

In yet another aspect, the present invention provides a herbicidal composition comprising a first active ingredient being clodinafop-propargyl and a second active ingredient being metsulfuron methyl, wherein said metsulfuron methyl is provided in a particulate form having a substantially homogenous barrier coating of hydrophobic inert material provided thereon and a process to prepare the same.

In further aspect, the present invention provides a herbicidal composition comprising clodinafop-propargyl in an amount of about 15% by weight of the composition, Cloquintocet mexyl in an amount of about 3.75% by weight of the composition, metsulfuron methyl in an amount of about 1% by weight of the composition, a dispersing agent in an amount of about 4% by weight of the composition, a wetting agent in an amount of about 17.5% by weight of the composition, a stabilizer in an amount of about 4% by weight of the composition, a hydrophobic inert material in an amount of about 8% by weight of the composition and an inert carrier in a sufficient quantity, wherein said metsulfuron methyl is provided in a particulate form having a substantially homogenous coating of said hydrophobic inert material.

In yet another aspect, the present invention provides a process for the preparation of a herbicidal composition, said process comprising:
(a) grinding provided metsulfuron on methyl to a predetermined particle size;
(b) mixing said ground metsulfuron methyl particles with a hydrophobic inert material to obtain homogenously coated particles of metsulfuron methyl;
(c) melting clodinafop-propargyl with cloquintocet mexyl in predetermined quantities;
(d) adding the melted product of steps (c) to at least one of the excipients selected from the group comprising dispersing agents, wetting agents and stabilizers;
(e) spraying the hot clodinafop liquid mixture obtained in the step (f), over inert carriers; and
(f) mixing a predetermined quantity of homogenous coated particles of metsulfuron methyl and Clodinafop pre-mix in suitable mixing equipment.

### DETAILED DESCRIPTION OF THE INVENTION

In accordance with a first aspect of the present invention, there is provided an agrochemical particles comprising metsulfuron methyl active ingredient particles substantially homogenously coated with hydrophobic inert material thereby increasing the stability of the metsulfuron methyl particles.

It has been found that uncoated particles of metsulfuron methyl undergo degradation on storage thus rendering it unstable. It has been surprisingly found by the present inventors that providing a homogenous coating on metsulfuron methyl particles with hydrophobic inert material confers an enhanced stability to the coated metsulfuron methyl. In other words, the degradation of metsulfuron methyl active ingredient is minimized by way of the present invention thereby increasing the stability which in turn increases the activity of the coated metsulfuron methyl particles over the uncoated particles of metsulfuron methyl.

The storage stability of the coated metsulfuron methyl particles of the present invention is compared with the uncoated metsulfuron methyl particles. The coated metsulfuron methyl particles of the present invention are tested for its active stability at elevated temperature (54±2° C.) and at pH of 4.5±0.2. It was found that uncoated metsulfuron methyl particles degrade by 62.73% whereas coated metsulfuron methyl particles do not degrade at all.

The findings of the present inventors clearly show that the activity of the uncoated metsulfuron methyl particles is reduced on storage due to degradation of metsulfuron methyl whereas the coated metsulfuron methyl particles of the present invention do not degrade on storage thus retaining the activity of active and hence have increased activity.

It has been reported in an article in Planta Daninha, Vol. 25, No. 4, 839-847, 117/07-08 entitled “Antagonism of associations of clodinafop-propargyl with metsulfuron-methyl & 2,4-D in the control of Italian Ryegrass (lolium multiflorum” that the association of clodinafop-propargyl with metsulfuron methyl reduces the control of Italian ryegrass by 28% as compared with clodinafop-propargyl used alone. Yet another reference by Kunz et al (2004) verified antagonism between clodinafop-propargyl and metsulfuron-methyl in sequential (successive) application for control of Avena sativa.

No prior art suggests the specific combination and benefits of combination of clodinafop-propargyl and metsulfuron methyl. The antagonism and degradation of actives further inhibit any likely progress. However, the present inventors have solved the problem of antagonism of combination of clodinafop-propargyl and metsulfuron methyl. Therefore, the present invention is a technological advancement over the prior art and solves the long felt need in the art by providing the herbicidal composition comprising combination of clodinafop-propargyl with metsulfuron methyl.

It has been surprisingly found by the present inventors that providing a homogenous coating on metsulfuron methyl particles with hydrophobic inert material confers an enhanced stability to the coated metsulfuron methyl in presence of clodinafop-propargyl. It has been found that when clodinafop-propargyl and metsulfuron methyl are tank mix, there is a marked percentage degradation of clodinafop-propargyl and metsulfuron methyl) proving that both actives have antagonistic effect and therefore are not stable when used in combination. Further plant mix of clodinafop-propargyl and metsulfuron methyl including precipitated silica, shows degradation of clodinafop-propargyl and metsulfuron methyl. The precipitated silica does not coat metsulfuron methyl and nor is able to retain the stability of metsulfuron methyl in the presence of clodinafop propargyl. It is also found that plant mix of clodinafop-propargyl and metsulfuron methyl including precipitated silica and colloidal silica in combination also show degradation of clodinafop-propargyl and metsulfuron methyl. The combination of silica does not coat metsulfuron methyl and nor retain the stability of metsulfuron methyl in the presence of clodinafop propargyl. Thus, the individual properties of clodinafop-propargyl and metsulfuron methyl decrease on mixing and therefore give less effect. A combination of, clodinafop-propargyl and metsulfuron methyl wherein the activities of both are retained is hitherto not known.

Without wishing to be bound by theory, it is found that the coating of hydrophobic inert material to the metsulfuron methyl active ingredient particles creates a protective barrier around the particles. The protective barrier thus formed protects the active ingredient, and particularly protects the sulfonyl urea bridge present in metsulfuron methyl, from coming into contact with other excipients or other active ingredients such as clodinafop-propargyl which are responsible for the reduced stability of the metsulfuron methyl particles thereby increasing the stability of metsulfuron methyl in the presence of clodinafop propargyl.

Therefore, it has been surprisingly found by way of the present invention that selective use of hydrophobic inert material coats the metsulfuron methyl active ingredient particles and creates a protective barrier around the particles thereby increasing the stability and activity of metsulfuron methyl particles per se and also in the presence of clodinafop propargyl.

Thus the herbicidal composition of the present invention is not only stable but also synergistic because the percentage degradation of the clodinafop-propargyl and metsulfuron methyl is minimized thus increasing the activity of the herbicidal composition.

In an embodiment, said metsulfuron methyl particles have a particle size of about 2 microns to about less than 200 microns. Preferably, said particles have a particle size of about less than 20 microns.

In another embodiment of this aspect of the present invention, the said hydrophobic inert material is chosen from a group comprising polymers, clays, silica, silicone derivatives, modified cellulose; modified starches, modified silicone dioxide, colloidal silica, precipitated silica, kaolin, china clay, natural and/or synthetic waxe(s), paraffin, paraffin liquid, wax and oils. The polymers as aforesaid may be preferably selected from polyvinyl pyrrolidone, polyvinyl alcohol, one or more gums such as rosin, stearic acid and the like. In a preferred embodiment, the hydrophobic inert material may be a mixture comprising one or more of the hydrophobic materials discussed hereinabove in any suitable proportion.

In another aspect, the present invention provides a process for preparing metsulfuron methyl active ingredient particles, said process comprising grinding provided metsulfuron methyl particles to a predetermined particle size and mixing said ground metsulfuron methyl particles in a predetermined quantity with a hydrophobic inert material to obtain homogenous hydrophobic coated particles of metsulfuron methyl.

In an embodiment, said metsulfuron methyl particles are ground to a particle size of about 2 microns to about less than 200 microns. Preferably, said particles are ground to a particle size of about less than 20 microns.

In another aspect, the present invention provides a herbicidal composition comprising a first active ingredient being clodinafop-propargyl and a second active ingredient being metsulfuron methyl, wherein said metsulfuron methyl is provided in a particulate form having a substantially homogenous coating of hydrophobic inert material provided thereon.

In an embodiment of this aspect of the present invention, said metsulfuron methyl particles have a particle size of about 0.2 microns to about less than 200 microns. Preferably, said particles have a particle size of about less than 20 microns.

In a preferred embodiment, clodinafop-propargyl active ingredient comprises about 0.1 to 50% and preferably 1.0 to 40% by weight of the composition. In another preferred embodiment, clodinafop-propargyl is present in an amount of about 2 to 30% by weight of the composition.

In another preferred embodiment, metsulfuron methyl active ingredient comprises about 0.01 to 40% and preferably 0.1% to 35% of the total weight of the composition. In another preferred embodiment, metsulfuron methyl is present in an amount of about 0.1 to 30.0% by total weight of the composition.

Without being bound by theory, it is believed that the coating of hydrophobic inert material to the metsulfuron methyl active ingredient particles creates a protective barrier around the particles. The protective barrier thus formed protects the active ingredient, and particularly protects the sulfonyl urea bridge present in metsulfuron methyl, from coming into contact with clodinafop-propargyl which is responsible for the reduced stability of the metsulfuron methyl particles to acidic pH conditions thereby fulfilling a long felt need in the art of providing a stable composition comprising metsulfuron methyl and clodinafop-propargyl.

In another embodiment, the composition comprises a safener Cloquintocet-mexyl that accelerates the rate of clodinafop-propargyl break down in crop, thus preventing the accumulation of a lethal dose. In a preferred embodiment, said safener is present in an amount of about 1% to about 50% by total weight of the clodinafop-propargyl. In another preferred embodiment, said safener is present in amount of about 0.01 to 25%, and preferably about 1 to 15% by total weight of the composition.

In another preferred embodiment, said composition includes at least one ingredient selected from a dispersing agent, a wetting/dispersing agent, a stabilizer and an inert ingredient.

The dispersing agent is preferably used in an amount of about 0.1 to about 40.0%, and preferably from about 1.0 to about 30.0% by total weight of the composition. In another preferred embodiment, the dispersing agent is present in an amount of about 2.0 to 20:0% by total weight of the composition.

The dispersing agent may be preferably selected from a group comprising lignosulphonates, phenyl naphthalene sulphonates, ethoxylated alkyl phenols, ethoxylated fatty acids, alkoxylated linear alcohols, polyaromatic sulfonates, sodium alkyl aryl sulfonates, maleic anhydride copolymers, phosphate esters, condensation products of aryl sulphonic acids and formaldehyde, addition products of ethylene oxide and fatty acid esters, sulfonates of condensed naphthalene, lignin derivatives, naphthalene formaldehyde condensates, polycarboxylates, sodium alkyl benzene sulfonates, salts of sulfonated naphthalene, ammonium salts of sulfonated naphthalene, salts of polyacrylic acids and salts of phenol sulfonic acids. In a preferred embodiment, the dispersing agent is sulphated poly aryl alkyl ethoxylate ammonium salt.

The wetting/dispersing agent is preferably used in an amount of about 0.5 to about 30.0%, and preferably from about 1.0 to about 30.0% by total weight of the composition. In another preferred embodiment, the wetting/dispersing agent is present in an amount of about 2.0 to 25.0% by total weight of the composition.

The wetting/dispersing agent may be preferably selected from a group comprising alkyl phenol ethoxylate, fatty oil ethoxylate, phenyl naphthalene sulphonates, alkyl naphthalene sulfonates, sodium alkyl naphthalene sulfonate, sodium salt of sulfonated alkyl carboxylate, polyoxyalkylated ethyl phenols, polyoxyethoxylated fatty alcohols, polyoxyethoxylated fatty amines, lignin derivatives, alkane sulfonates, alkylbenzene sulfonates, salts of polycarboxylic acids, salts of esters of sulfosuccinic acid, alkylpolyglycol ether sulfonates, alkyl ether phosphates, alkyl ether sulfates and alkyl sulfosuccinic monoesters.

In a preferred embodiment, the wetting/dispersing agent is a mixture of alkyl phenol ethoxylate and fatty oil ethoxylate in a ratio of 10:1 to 1:10, wherein preferably the alkyl phenol ethoxylate is present in an amount of about 16.00% and fatty oil ethoxylate is present in amount of abut 1.5% by total weight of the composition in Clodinafop propargyl (15%)+Metsulfuron methyl (1%) 16% WP.

It was found that in compositions comprising the dispersing and wetting/dispersing agents such as herein above described, the composition particles did not exhibit any flocculation tendencies, which was observed with hitherto known compositions as ready mix or tank mix products, during dilution and field application. It was further found that the absence of the flocculation tendencies was observed with the specific choice of a mixture of alkyl phenol ethoxylate and fatty oil ethoxylate as the vetting/dispersing agent which therefore form a preferred embodiment of the wetting/dispersing agents described herein though other combinations of wetting/dispersing agents may also be used.

The compositions of the present invention optionally further include a stabilizer. The stabilizer is preferably used in an amount of about 0.01 to about 20.0%, and more preferably from about 0.05 to about 18.0% by total weight of the composition. In another preferred embodiment, the stabilizer is present in an amount of about 0.1 to 15.0% by total weight of the composition.

The stabilizer may be preferably selected from a group comprising epoxidized soybean oil, gamma butyrolactone, butylated hydroxyl toluene and its derivatives, epichlorhydrin, buffering agents, quinone derivatives, hydrazine hydrates and its derivatives, general class UV stabilizers, glycols and its derivatives and mixtures thereof.

The compositions according to the present invention optionally comprise an inert carrier(s)/ingredient present in an amount of about 10.0 to about 99.0% and preferably about 15.0 to about 98.0% of the total weight of the composition. In a further preferred embodiment, the compositions of the present invention comprise an inert carrier(s)/ingredient in an amount of from about 20.0 to about 95.0% by weight of the composition.

In a preferred embodiment, the inert ingredient is chosen from a group comprising hydrophobic inert material clays, silica, modified cellulose, modified silicone di-oxide, modified starches, silicone derivatives, natural and/or synthetic waxe(s), paraffins, paraffin liquids, polymers (Polyvinyl pyrrolidone {PVP}, Polyvinyl alcohol {PVA}, Gum like rosin, Stearic acid etc.), wax and oils, which ingredient is believed to form a protective coating such as hereinabove described on the metsulfuron methyl particles. The inert carrier(s) is selected from colloidal silica, precipitated silica, kaolin, clay, china clay or a mixture thereof.

The compositions of the present invention may be preferably formulated as wettable powders though other formulations such as ready to spray suspensions and emulsions are also included. The wettable powder of the present invention may be suitably dispersed in water at a suitable proportion to provide aqueous compositions that can be applied at a suitable spray rate.

In a most preferred embodiment, the present invention provides a herbicidal composition comprising clodinafop-propargyl content about 15% by weight of the composition, Cloquintocet mexyl content about 3.75% by weight of the composition as safener, metsulfuron methyl content about 1% by weight of the composition, a dispersing agent about 4% by weight of the composition, a wetting/dispersing agent about 17.5% by weight of the composition, a stabilizer about 4% by weight of the composition, a barrier forming (hydrophobic) inert material about 8% by weight of the composition and inert carrier(s) approximately 46.75% by weight of the composition to make the 100% by weight of the composition; wherein said metsulfuron methyl is provided in a particulate form having a substantially homogenous coating of said hydrophobic inert material as a barrier forming inert material, provided thereon.

In other most preferred embodiment, the present invention provides a herbicidal composition comprising clodinafop-propargyl content about 15% by weight of the composition, Cloquintocet mexyl content about 3.75% by weight of the composition as safener, metsulfuron methyl content about 1% by weight of the composition, a dispersing agent about 4% by weight of the composition, a wetting/dispersing agent about 17.5% by weight of the composition, a stabilizer about 4% by weight of the composition, a barrier forming material about 8.0% by weight of the composition and inert carrier(s) in a sufficient quantity to make the 100% by weight of the composition; wherein said metsulfuron methyl is provided in a particulate form having a substantially homogenous coating of said hydrophobic inert material as a barrier forming inert material, provided thereon.

In another aspect, the present invention provides a process for the preparation of a herbicidal composition, said process comprising:
(a) grinding provided metsulfuron methyl to a predetermined particle size;
(b) mixing said ground metsulfuron methyl particles with a hydrophobic inert material to obtain homogenously coated particles of metsulfuron methyl;
(c) melting clodinafop-propargyl with cloquintocet mexyl in predetermined quantities;
(d) adding the melted product of steps (c) to at least one of the excipients selected from the group comprising dispersing agents, wetting agents and stabilizers;
(e) spraying the hot clodinafop liquid mixture obtained in the step (d), over inert carriers; and
(f) mixing a predetermined quantity of homogenous coated particles of metsulfuron methyl and Clodinafop pre-mix in a suitable mixing equipment.

In a preferred embodiment, the product of step (d) is heated to obtain a homogenous clodinafop liquid comprising Clodinafop-propargyl, being substantially free of solid particles and is optionally maintained at temperature of about 35 to about 80° C.

In a further preferred embodiment, the process comprises mixing the product of step (e) for an additional predetermined amount of time to obtain Clodinafop pre-mix in a free flowing powder form before mixing the same with homogenous coated particles of metsulfuron methyl.

The process disclosed above may be conveniently employed to provide compositions having the following amounts of the ingredients:

| S. No. | Ingredient(s) | Range (%) |
|---|---|---|
| 1 | Clodinafop-propargyl | 0.10 to 50.00 |
| 2 | Cloquintocet mexyl | 0.01 to 25.00 |
| 3 | Metsulfuron methyl | 0.01 to 40.00 |
| 4 | Dispersing agent | 0.10 to 40.00 |
| 5 | Wetting/dispersing agent | 0.50 to 30.00 |
| 6. | Stabilizer | 0.01 to 20.00 |
| 7. | Inert ingredient(s) including barrier forming agent | Q.S. |

| | |
|---|---|
| Total | 100.000% |

The invention shall now be described with reference to the following non-limiting and exemplary embodiments. Parts and percentage are by weight unless otherwise specified.

### Example 1

Clodianfop propargyl (15%)+Metsulfuron methyl (1%) 16% WP can be prepared as follows:

| S. No. | Ingredient(s) | Quantity (gm) |
|---|---|---|
| 1 | Clodinafop-propargyl (active content) | 15.00 |
| 2 | Cloquintocet mexyl | 3.75 |
| 3 | Metsulfuron methyl (active content) | 1.00 |
| 4 | Dispersing agent (Sulphated poly aryl alkyl | 4.000 |
| | ethoxylate ammonium salt)) | |
| 5 | Wetting/dispersing agent | |
| | a) Fatty-oil ethoxylate | 1.500 |
| | b) Alkyl phenol ethoxylate | 16.000 |
| 6. | Stabilizer (Epoxydised fatty oil) | 4.000 |
| 7. | Inert ingredient(s) | |
| | a) modified silicone di-oxide (hydrophobic) | 8.000 |
| | b) Colloidal silica | 46.75 |

| | | |
|---|---|---|
| Total | 100.000 | gm |

The provided metsulfuron methyl was ground to a particle size of average 20 micron. The ground metsulfuron methyl was mixed in required quantity with the modified silicone dioxide (hydrophobic) inert material to form a barrier in a suitable blender to provide the homogenous powder of Metsulfuron-methyl pre mix. The provided Clodinafop propargyl was melted with cloquintocet mexyl in required quantity. The above melted product was added with sulphated poly aryl alkyl ethoxylate ammonium salt, fatty-oil ethoxylate, alkyl phenol ethoxylate and epoxydised fatty oil and heated to obtain a homogenous Clodinafop liquid mixture, free from solid particles. The temperature of Clodinafop liquid mixture was maintained between 35 to 80° C. The molten clodinafop liquid mixture was sprayed over the colloidal silica in a suitable mixing equipment. The product of the above step was mixed for an additional time to finally obtain Clodinafop pre-mix in a free flowing powder form. A required quantity of Metsulfuron methyl pre-mix and Clodinafop pre-mix were mixed in a suitable mixer. The homogeneity of the product was confirmed by known quality assurance techniques to obtain the herbicidal composition. The approved product was thereafter packed in required pack sizes.

The process outlined above was employed to provide exemplary compositions with little or no modifications according to the present invention having the following ingredients in the indicated relative percentages:

### Example-2

Clodianfop propargyl (15%)+Metsulfuron methyl (1%) 16% WP can be prepared as per the following composition:

The provided metsulfuron methyl was ground to a particle size of average 20 micron. The ground metsulfuron methyl was mixed in required quantity with the modified silicone dioxide (hydrophobic) inert material to form a barrier in a suitable blender to provide the homogenous powder of Metsulfuron-methyl pre mix. The provided Clodinafop propargyl was melted with cloquintocet mexyl in required quantity. The above melted product was added with sulphated poly aryl alkyl ethoxylate ammonium salt, fatty-oil ethoxylate, alkyl phenol ethoxylate and epoxydised fatty oil and heated to obtain a homogenous Clodinafop liquid mixture, free from solid particles. The temperature of Clodinafop liquid mixture was maintained between 35 to 80° C. The molten clodinafop liquid mixture was sprayed over the precipitated silica in suitable mixing equipment. The product of the above step was mixed for an additional time to finally obtain Clodinafop pre-mix in a free flowing powder form. A required quantity of Metsulfuron methyl pre-mix and Clodinafop pre-mix were mixed in a suitable mixer. The homogeneity of the product was confirmed by known quality assurance techniques. The approved product was thereafter packed in required pack sizes. The amounts of the various ingredients were used according to the following exemplary and non-limiting composition.

| S. No. | Ingredient(s) | Quantity (gm) |
|---|---|---|
| 1 | Clodinafop-propargyl | 15.00 |
| 2 | Cloquintocet mexyl | 3.75 |
| 3 | Metsulfuron methyl | 1.00 |
| 4 | Dispersing agent (Sulphated poly aryl alkyl | 4.000 |
| | ethoxylateammonium salt)) | |
| 5 | Wetting/dispersing agent | |
| | a) Fatty-oil ethoxylate | 1.500 |
| | b) Alkyl phenol ethoxylate | 16.000 |
| 6. | Stabilizer (Epoxydised fatty oil) | 4.000 |
| 7. | Inert ingredient(s) | |
| | a) modified silicone di-oxide(hydrophobic) | 8.000 |
| | b) precipitated silica | 46.75 |

| | | |
|---|---|---|
| Total | 100.000 | gm |

### Example-3

Clodianfop propargyl (15%)+Metsulfuron methyl (1%) 16% WP can be prepared as per the following composition:

| S. No. | Ingredient(s) | Quantity (gm) |
|---|---|---|
| 1 | Clodinafop-propargyl purity 95% (base 15.0%) | 15.790 |
| 2 | Cloquintocet mexyl purity 95% (base 3.75%) | 3.948 |
| 3 | Metsulfuron methyl purity 95% (base 1.0%) | 1.053 |
| 4 | Dispersing agent (Sulphated poly aryl alkyl | 4.000 |
| | ethoxylate ammonium salt)) | |
| 5 | Wetting/dispersing agent | |
| | a) Castor-oil ethoxylate-40 mole | 1.500 |
| | b) Ethoxylated alkyl phenol | 16.000 |
| 6. | Stabilizer (Epoxydised soya bean oil) | 4.000 |
| 7. | Inert ingredient(s) | |
| | a) hydrophobic silica powder | 8.000 |
| | b) colloidal silica | 45.709 |

| | | |
|---|---|---|
| Total | 100.000 | gm |

Clodianfop propargyl (15%)+Metsulfuron methyl (1%) 16% WP with above composition can be prepared by the process described in example-2.

### Example-4

Clodianfop propargyl (10%)+Metsulfuron methyl (2%) 12% WP can be prepared as per the following composition:

| S. No. | Ingredient(s) | Quantity (gm) |
|---|---|---|
| 1 | Clodinafop-propargyl purity 95% (base 10.0%) | 10.526 |
| 2 | Cloquintocet mexyl purity 94% (base 2.50%) | 2.660 |
| 3 | Metsulfuron methyl purity 95% (base 2.0%) | 2.105 |
| 4 | Dispersing agent (Sulphated poly aryl alkyl | 3.500 |
| | ethoxylate ammonium salt)) | |
| 5 | Wetting/dispersing agent | |
| | a) Castor-oil Ethoxylate-40 mole | 1.500 |
| | b) Ethoxylated alkyl phenol | 22.000 |
| 6. | Stabilizer (Epoxydised soya bean oil) | 4.000 |
| 7. | Inert ingredient(s) | |
| | a) modified silicone di-oxide | 12.000 |
| | b) Colloidal silica | 41.709 |

| | | |
|---|---|---|
| Total | 100.000 | gm |

Clodianfop propargyl (10%)+Metsulfuron methyl (2%) 12% WP with above composition can be prepared by the process described in example-2.

### Example-5

Clodianfop propargyl (10%)+Metsulfuron methyl (2%) 12% WP can be prepared as per the following composition:

| S. No. | Ingredient(s) | Quantity (gm) |
|---|---|---|
| 1 | Clodinafop-propargyl active ingredient | 10.00 |
| 2 | Cloquintocet mexyl | 2.50 |
| 3 | Metsulfuron methyl active ingredient | 2.00 |
| 4 | Dispersing agent (Sodium alkyl aryl sulphate) | 6.00 |
| 5 | Phenyl naphthalene sulfonateCastor-oil | 3.50 |
| | Ethoxylate | |
| 6 | Ethoxylated alkyl phenol | 12.00 |
| 7 | Epoxydised soya bean oil | 3.00 |
| 8 | Modified silicone di-oxide/Hydrophobic silica | 1.60 |
| | powder | |
| 9 | Colloidal silica | 59.40 |

| | | |
|---|---|---|
| Total | 100.00 | gm |

The provided metsulfuron methyl was ground to a particle size of average 20 micron. The ground metsulfuron methyl was mixed in required quantity with the modified silicone dioxide (hydrophobic) inert material to form a barrier in a suitable blender to provide the homogenous powder of Metsulfuron-methyl pre mix. The provided Clodinafop propargyl was melted with cloquintocet mexyl in required quantity. The above melted product was added with sulphated poly aryl alkyl ethoxylate ammonium salt, fatty-oil ethoxylate, alkyl phenol ethoxylate and epoxydised fatty oil and heated to obtain a homogenous Clodinafop liquid mixture, free from solid particles. The temperature of Clodinafop liquid mixture was maintained between 35 to 80° C. The molten clodinafop liquid mixture was sprayed over the colloidal silica in a suitable mixing equipment. The product of the above step was mixed for an additional time to finally obtain Clodinafop pre-mix in a free flowing powder form. A required quantity of Metsulfuron methyl pre-mix and Clodinafop pre-mix were mixed in a suitable mixer. The homogeneity of the product was confirmed by known quality assurance techniques to obtain the herbicidal composition of this invention. The approved product was thereafter packed in required pack sizes.

### Example-6

Clodianfop propargyl (5%)+Metsulfuron methyl (5%) 10% WP can be prepared as per the following composition:

| S. No. | Ingredient(s) | Quantity (gm) |
|---|---|---|
| 1 | Clodinafop-propargyl active ingredient | 5.00 |
| 2 | Cloquintocet mexyl | 1.20 |
| 3 | Metsulfuron methyl active ingredient | 5.00 |
| 4 | Dispersing agent (Naphtalene formaldehyde | 10.00 |
| | condensate) | |
| 5 | Castor-oil ethoxylate | 2.50 |
| 6 | Sodium salt of suphonated alkyl carboxylate | 20.00 |
| 7 | Stabilizer (Epoxydised soya bean oil) | 5.00 |
| 8 | Modified silicone di-oxide/Hydorphobic | 5.00 |
| | silica powder | |
| 9 | colloidal silica | 46.30 |

| | | |
|---|---|---|
| Total | 100.000 | gm |

Clodianfop propargyl (5%)+Metsulfuron methyl (5%) 10% WP with above composition can be prepared by the process described in example-5.

### Example-7

Clodianfop propargyl (20%)+Metsulfuron methyl (5%) 25% WP can be prepared as per the following composition:

| S. No. | Ingredient(s) | Quantity (gm) |
|---|---|---|
| 1 | Clodinafop-propargyl active ingredient | 20.00 |
| 2 | Cloquintocet mexyl | 10.00 |
| 3 | Metsulfuron methyl active ingredient | 5.00 |
| 4 | Sodium alkyl benzene sulphonate | 7.00 |
| 5 | Castor-oil ethoxylate | 3.00 |
| 6 | Ethoxylated alkyl phenol | 10.00 |
| 7 | Stabilizer (Epoxydised soya bean oil) | 5.00 |
| 8 | Polyvinyl pyrrolidone K-30 | 1.00 |
| 9 | colloidal silica | 39.00 |

| | | |
|---|---|---|
| Total | 100.000 | gm |

The provided metsulfuron methyl was ground to a particle size of average 20 micron. The ground metsulfuron methyl was mixed in required quantity with a solution of the Polyvinyl pyrrolidone (in Isopropyl alcohol/methanol/acetone or any suitable solvent) thoroughly to form a barrier on the Metsulfuron methyl ground powder. Thereafter this material was dried to nullify the solvent presence. The coating of the Metsulfuron methyl particles can alternately be done by another method in which the solution of coating agent is being sprayed on to the Metsulfuron methyl particles in a suitable equipment. The product obtained, if required, can be optionally dried to have the homogenous powder of Metsulfuron-methyl pre mix. The provided Clodinafop propargyl was melted with cloquintocet mexyl m required quantity. The above melted product was added with sulphated poly aryl alkyl ethoxylate ammonium salt, fatty-oil ethoxylate, alkyl phenol ethoxylate and epoxydised fatty oil and heated to obtain a homogenous Clodinafop liquid mixture, free from solid particles. The temperature of Clodinafop liquid mixture was maintained between 35 to 80° C. The molten clodinafop liquid mixture was sprayed over the colloidal silica in a suitable mixing equipment. The product of the above step was mixed for an additional time to finally obtain Clodinafop pre-mix in a free flowing powder form. A required quantity of Metsulfuron methyl pre-mix and Clodinafop pre-mix were mixed in a suitable mixer to obtain the herbicidal composition of this invention. The homogeneity of the product was confirmed by known quality assurance techniques. The approved product was thereafter packed in required pack sizes.

### Example-8

Clodianfop propargyl (15%)+Metsulfuron methyl (3%) 18% WP can be prepared as per the following composition:

| S. No. | Ingredient(s) | Quantity (gm) |
|---|---|---|
| 1 | Clodinafop-propargyl active ingredient | 15.00 |
| 2 | Cloquintocet mexyl | 4.00 |
| 3 | Metsulfuron methyl active ingredient | 3.00 |
| 4 | Sulphated poly aryl alkyl ethoxylate | 13.00 |
| | ammonium salt | |
| 5 | Castor-oil ethoxylate | 4.00 |
| 6 | Sodium alkyl naphthalene sulphonate | 11.00 |
| 7 | Stabilizer (Epoxydised soya bean oil) | 2.00 |
| 8 | Colloidal silica | 48.00 |

| | | |
|---|---|---|
| Total | 100.000 | gm |

Clodianfop propargyl (15%)+Metsulfuron methyl (3%) 18% WP with above composition can be prepared by the process described in example-1 whereas the grinded Metsulfuron methyl is mixed with 25% of the total Colloidal Silica required.

### Example-9

Clodianfop propargyl (20%)+Metsulfuron methyl (1%) 21% WP can be prepared as per the following composition:

| S. No. | Ingredient(s) | Quantity (gm) |
|---|---|---|
| 1 | Clodinafop-propargyl active ingredient | 20.00 |
| 2 | Cloquintocet mexyl | 5.00 |
| 3 | Metsulfuron methyl active ingredient | 1.00 |
| 4 | Sulphated poly aryl alkyl ethoxylate | 10.00 |
| | ammonium salt | |
| 5 | Castor-oil ethoxylate | 4.00 |
| 6 | Ethoxylated alkyl phenol | 10.00 |
| 7 | Stabilizer (Epoxydised soya bean oil) | 5.00 |
| 8 | Hydrophobic silica | 3.00 |
| 9 | colloidal silica | 42.00 |

| | | |
|---|---|---|
| Total | 100.000 | gm |

Clodianfop propargyl (20%)+Metsulfuron methyl (1%) 21% WP with above composition can be prepared by the process described in example-7.

### Example-10

Clodianfop propargyl (10%)+Metsulfuron methyl (1%) 11% WP can be prepared as per the following composition:

| S. No. | Ingredient(s) | Quantity (gm) |
|---|---|---|
| 1 | Clodinafop-propargyl active ingredient | 10.00 |
| 2 | Cloquintocet mexyl | 2.50 |
| 3 | Metsulfuron methyl active ingredient | 1.00 |
| 4 | Sulphated poly aryl alkyl ethoxylate | 10.00 |
| | ammonium salt | |
| 5 | Castor-oil ethoxylate | 1.50 |
| 6 | Alkyl benzene sulphonate | 15.00 |
| 7 | Stabilizer (Epoxydised soya bean oil) | 5.00 |
| 8 | Hydrophobic silica | 2.00 |
| 9 | colloidal silica | 53.00 |

| | | |
|---|---|---|
| Total | 100.000 | gm |

Clodianfop propargyl (10%)+Metsulfuron methyl (1%) 11% WP with above composition can be prepared by the process described in example-7.

### Example-11

Clodianfop propargyl (15%)+Metsulfuron methyl (1%) 16% WP can be prepared as per the following composition:

| S. No. | Ingredient(s) | Quantity (gm) |
|---|---|---|
| 1 | Clodinafop-propargyl technical of purity 95% | 15.790 |
| 2 | Cloquintocet mexyl technical of purity 95% | 3.948 |
| 3 | Metsulfuron methyl technical of purity 95% | 1.053 |
| 4 | Sulphated poly aryl alkyl ethoxylate | 4.000 |
| | ammonium salt | |
| 5 | Wetting/dispersing agent | |
| | a) Fatty-oil ethoxylate | 1.500 |
| | b) Alkyl phenol ethoxylate | 16.000 |
| 6 | Stabilizer (Epoxydised fatty oil) | 4.000 |
| 7 | Inert ingredient(s) | |
| | a) Aerosil R 972 (Hydrophobic silica) | 8.000 |
| | b) Colloidal silica | 52.909 |

| | | |
|---|---|---|
| Total | 100.000 | gm |

Clodianfop propargyl (15%)+Metsulfuron methyl (1%) 16% WP with above composition can be prepared by the process described in example-2.

### Example-12

Clodianfop propargyl (10%)+Metsulfuron methyl (2%) 12% WP can be prepared as per the following composition:

| S. No. | Ingredient(s) | Quantity (gm) |
|---|---|---|
| 1 | Clodinafop-propargyl active content | 10.00 |
| 2 | Cloquintocet mexyl active content | 2.50 |
| 3 | Metsulfuron methyl active ingredient | 2.00 |
| 4 | Sulphated poly aryl alkyl ethoxylate | 2.50 |
| | ammonium salt | |
| 5 | Castor-oil ethoxylate-40 mole | 3.50 |
| 6 | Ethoxylated alkyl phenol | 10.00 |
| 7 | Epoxydised soya bean oil | 3.00 |
| 8 | Modified silicone di-oxide | 1.60 |
| 9 | Colloidal silica | 64.90 |

| | | |
|---|---|---|
| Total | 100.000 | gm |

Clodianfop propargyl (10%)+Metsulfuron methyl (2%) 12% WP with above composition can be prepared by the process described in example-5.

Wettable powders can also be prepared in the manner as explained in above examples, except that the portions of the active ingredients Clodinafop propargyl and Metsulfuron methyl were inter-changed so as to provide further compositions according to the invention for use and also comparative composition analysis. The effective composition can be obtained by maintaining the pH of the final product nearer to the stable formulation product of active ingredient in dominated strength.

The following physical properties relating to the quality of these Clodinafop propargyl+Metsulfuron methyl Formulations are determined before and after ageing at 54±2° C. for 500 hrs like Description, Active ingredient(s), pH, wet sieve test, Suspensibility, persistent foam and Wettability. No noticeable difference in all the above properties observed.

The description is determined by visual observations.

The appearance for colour and physical state of the test substance is determined by visual inspection.

The active ingredient(s) like Clodinafop propargyl content, Cloquintocet mexyl content and Metsulfuron methyl content was determined by using their respective AOAC/CIPAC methods of analysis. The Wettability is determined by as per (CIPAC MT 53.3.1). The Suspensibility is determined as per (CIPAC MT 168). The Wet sieve test is determined as per (CIPAC MT 167). The Acidity is determined as per (CIPAC MT 191).

Collaborative International Pesticides Analytical Council (CIPAC) and AOAC International (AOAC) publish methods of analysis, which may preferably be used for collaborative testing according to the present invention.

### Improved Stability of the Metsulfuron Methyl Particles

The storage stability of the coated metsulfuron methyl particles of the present invention is compared with the uncoated metsulfuron methyl particles. The coated metsulfuron methyl particles of the present invention are tested for its active stability at elevated temperature (54±2° C.) and at pH of 4.5±0.2 as shown below:

| | | Metsulfuron methyl | | |
|---|---|---|---|---|
| | | content after | | |
| | Details | 0 day | 14 days | % degradation |
| 1 | Without modified | 1.1 | 0.41 | 62.73 |
| | silicon dioxide | | | |
| 2 | With modified | 1.08 | 1.08 | 0 |
| | silicon dioxide | | | |

The above results clearly show that the homogenous coating of the modified silicon dioxide provides a stabilized metsulfuron methyl particles that in turn increases its activity/efficacy also.

### Improved Stability of the Herbicidal Composition

To determine the versatility and universal applicability of the coating system for Metsulfuron methyl for the preparation of a herbicidal composition comprising Clodinafop propargyl and Metsulfuron methyl for control of herbs and/or weeds in crop filed. A comparative study was made for this technique with different coating agents commercially recommended and the coating agent(s) according to the present invention individually and/or in combination.

The numbers of formulations were made up as described in above examples. The concentration of Clodinafop propargyl (15%)+Metsulfuron methyl (1%) 16% WP was tested for its active stability at elevated temperature (54±2° C.) and at 3 different pH ranges as shown below.

The storage stability of the compositions according the present invention was compared with the storage stability of compositions individually and in combination as Tank, mix and plant mixes. The term Tank mix means that clodinafop-propargyl and metsulfuron methyl are mixed in the tank at the time of spraying. The term plant mix means that ready mix of the clodinafop-propargyl and metsulfuron methyl are diluted in the tank before spraying.

TABLE 1
Comparison of active ingredient content before (0 day) and after (14 days)
Accelerated Heat Stability (54 ± 1° C.) treatment for products having a pH of 4.5 ± 0.2.
At pH 4.5 ± 0.2

| | | Clodinafop propargyl + | | | | | | | |
|---|---|---|---|---|---|---|---|---|---|
| | | Metsulfuron methyl) | | Clodinafop propargyl | | | Metsulfuron methyl content | | |
| | | active ingredient | | content after | | | after | | |
| | Details/ | Clodinafop | Metsulfuron | 0 | 14 | % | 0 | 14 | % |
| | Example No | propargyl | methyl | day | days | degradation | day | days | degradation |
| 1 | Clodinafop | 15 | 0 | 15.56 | 15.41 | 0.964 | — | — | — |
| | propargyl | | | | | | | | |
| | WP | | | | | | | | |
| 2. | Metsulfuron | 0 | 20 | — | — | — | 20.22 | 15.23 | 24.679 |
| | methyl 20% | | | | | | | | |
| | WP | | | | | | | | |
| 3. | Clodinafop | 15 | 1 | 15.32 | 12.506 | 18.368 | 1.10 | 0.250 | 77.28 |
| | propargyl + | | | | | | | | |
| | Metsulfuron | | | | | | | | |
| | methyl (tank | | | | | | | | |
| | mix) | | | | | | | | |
| 4. | Clodinafop | 15 | 1 | 15.30 | 13.068 | 14.588 | 1.22 | 0.89 | 27.05 |
| | propargyl + | | | | | | | | |
| | Metsulfuron | | | | | | | | |
| | methyl | | | | | | | | |
| | (Plant mix | | | | | | | | |
| | using | | | | | | | | |
| | precipitated | | | | | | | | |
| | silica only) | | | | | | | | |
| 5. | Clodinafop | 15 | 1 | 15.22 | 13.824 | 9.172 | 1.09. | 0.99 | 9.175 |
| | propargyl + | | | | | | | | |
| | Metsulfuron | | | | | | | | |
| | methyl | | | | | | | | |
| | (Plant mix | | | | | | | | |
| | using | | | | | | | | |
| | Precipitated | | | | | | | | |
| | silica and | | | | | | | | |
| | colloidal | | | | | | | | |
| | silica in | | | | | | | | |
| | combination) | | | | | | | | |
| 6. | Clodinafop | 15 | 1 | 15.25 | 15.120 | 0.853 | 1.08 | 1.08 | 0.00 |
| | propargyl + | | | | | | | | |
| | Metsulfuron | | | | | | | | |
| | methyl | | | | | | | | |
| | composition | | | | | | | | |
| | according to | | | | | | | | |
| | the present | | | | | | | | |
| | invention | | | | | | | | |

TABLE 2
Comparison of active ingredient content before (0 day) and after (14 days)
Accelerated Heat Stability (54 ± 1° C.) treatment for products
having a pH of 6.8 ± 0.2.
At pH 6.8 ± 0.2

| | | Clodinafop propargyl + | | | | | | | |
|---|---|---|---|---|---|---|---|---|---|
| | | Metsulfuron methyl) | | Clodinafop propargyl | | | Metsulfuron methyl content | | |
| | | active ingredient | | content after | | | after | | |
| | Details/ | Clodinafop | Metsulfuron | 0 | 14 | % | 0 | 14 | % |
| S. No. | Example No | propargyl | methyl | day | days | degradation | day | days | degradation |
| 1 | Clodinafop | 15 | 0 | 15.42 | 15.03 | 2.53 | — | — | — |
| | propargyl | | | | | | | | |
| | WP | | | | | | | | |
| 2. | Metsulfuron | 0 | 20 | — | — | — | 20.35 | 17.776 | 12.649 |
| | methyl 20% | | | | | | | | |
| | WP | | | | | | | | |
| 3. | Clodinafop | 15 | 1 | 15.24 | 10.653 | 30.099 | 1.12 | 0.262 | 76.61 |
| | propargyl + | | | | | | | | |
| | Metsulfuron | | | | | | | | |
| | methyl (tank | | | | | | | | |
| | mix) | | | | | | | | |
| 4. | Clodinafop | 15 | 1 | 15.25 | 11.823 | 22.472 | 1.06 | 0.88 | 16.98 |
| | propargyl + | | | | | | | | |
| | Metsulfuron | | | | | | | | |
| | methyl | | | | | | | | |
| | (Plant mix | | | | | | | | |
| | using | | | | | | | | |
| | precipitated | | | | | | | | |
| | silica only) | | | | | | | | |
| 5. | Clodinafop | 15 | 1 | 15.18 | 12.60 | 16.996 | 1.1 | 1.02 | 7.273 |
| | propargyl + | | | | | | | | |
| | Metsulfuron | | | | | | | | |
| | methyl | | | | | | | | |
| | (Plant mix | | | | | | | | |
| | using | | | | | | | | |
| | Precipitated | | | | | | | | |
| | silica and | | | | | | | | |
| | colloidal | | | | | | | | |
| | silica in | | | | | | | | |
| | combination) | | | | | | | | |
| 6. | Clodinafop | 15 | 1 | 15.42 | 14.01 | 9.144 | 1.06 | 1.057 | 0.28 |
| | propargyl + | | | | | | | | |
| | Metsulfuron | | | | | | | | |
| | methyl | | | | | | | | |
| | composition | | | | | | | | |
| | according to | | | | | | | | |
| | the present | | | | | | | | |
| | invention | | | | | | | | |

TABLE 3
Comparison of active ingredient content before (0 day) and after (14 days)
Accelerated Heat Stability (54 ± 1° C.) treatment for products
having a pH of 8.5 ± 0.2.
At pH 8.5 ± 0.2

| | | Clodinafop propargyl + | | | | | | | |
|---|---|---|---|---|---|---|---|---|---|
| | | Metsulfuron methyl) | | Clodinafop propargyl | | | Metsulfuron methyl content | | |
| | | active ingredient | | content after | | | after | | |
| | Details/ | Clodinafop | Metsulfuron | 0 | 14 | % | 0 | 14 | % |
| S. No. | Example No | propargyl | methyl | day | days | degradation | day | days | degradation |
| 1 | Clodinafop | 15 | 0 | 15.59 | 14.42 | 7.505 | — | — | — |
| | propargyl | | | | | | | | |
| | WP | | | | | | | | |
| 2. | Metsulfuron | 0 | 20 | — | — | — | 20.40 | 19.416 | 4.824 |
| | methyl 20% | | | | | | | | |
| | WP | | | | | | | | |
| 3. | Clodinafop | 15 | 1 | 15.40 | 7.673 | 50.176 | 1.112 | 0.34 | 69.43 |
| | propargyl + | | | | | | | | |
| | Metsulfuron | | | | | | | | |
| | methyl (tank | | | | | | | | |
| | mix) | | | | | | | | |
| 4. | Clodinafop | 15 | 1 | 15.36 | 9.708 | 36.797 | 1.18 | 1.04 | 11.864 |
| | propargyl + | | | | | | | | |
| | Metsulfuron | | | | | | | | |
| | methyl | | | | | | | | |
| | (Plant mix | | | | | | | | |
| | using | | | | | | | | |
| | precipitated | | | | | | | | |
| | silica only) | | | | | | | | |
| 5. | Clodinafop | 15 | 1 | 15.32 | 10.980 | 28.329 | 1.07 | 1.065 | 0.468 |
| | propargyl + | | | | | | | | |
| | Metsulfuron | | | | | | | | |
| | methyl | | | | | | | | |
| | (Plant mix | | | | | | | | |
| | using | | | | | | | | |
| | Precipitated | | | | | | | | |
| | silica and | | | | | | | | |
| | colloidal | | | | | | | | |
| | silica in | | | | | | | | |
| | combination) | | | | | | | | |
| 6. | Clodinafop | 15 | 1 | 15.25 | 13.44 | 11.862 | 1.11 | 1.11 | 0.00 |
| | propargyl + | | | | | | | | |
| | Metsulfuron | | | | | | | | |
| | methyl | | | | | | | | |
| | according to | | | | | | | | |
| | the present | | | | | | | | |
| | invention | | | | | | | | |

### Conclusion:

It has been seen that clodinafop-propargyl degrades by 0.96% at pH 4.5 and metsulfuron methyl degrades by 24.67%. Further, clodinafop-propargyl degrades by 2.5% at pH 6.8 and metsulfuron methyl degrades by 12.64%. Finally, clodinafop-propargyl degrades by 7.5% at pH 8.5 and metsulfuron methyl degrades by 4.82%.

Further when clodinafop-propargyl and metsulfuron methyl are tank mix, there is a marked percentage degradation of clodinafop-propargyl and metsulfuron methyl proving that both actives have antagonistic effect and therefore are not stable when used in combination. Further plant mix of clodinafop-propargyl and metsulfuron methyl including precipitated silica, shows degradation of clodinafop-propargyl and metsulfuron methyl. The precipitated silica does not coat metsulfuron methyl and nor is able to retain the stability of metsulfuron methyl in the presence of clodinafop propargyl. It is also found that plant mix of clodinafop-propargyl and metsulfuron methyl including precipitated silica and colloidal silica in combination also show degradation of clodinafop-propargyl and metsulfuron methyl. The combination of silica does not coat metsulfuron methyl and nor retain the stability of metsulfuron methyl in the presence of clodinafop propargyl.

However the coating of hydrophobic inert material to the metsulfuron methyl active ingredient particles creates a protective barrier around the particles. The protective barrier thus formed protects the active ingredient, and particularly protects the sulfonyl urea bridge present in metsulfuron methyl, from coming into contact with other excipients or other active ingredients such as clodinafop-propargyl which are responsible for the reduced stability of the metsulfuron methyl particles thereby increasing the stability of metsulfuron methyl in the presence of clodinafop propargyl.

The above tables—1, 2 and 3 results shows that the accelerated storage stability of the compositions according the present invention was more stable in accelerated storage in comparison to the other comparative compositions. The compositions according to the present invention and the processes for the preparation thereof makes the Metsulfuron methyl active content more stable in wide pH range. The compositions according to the present invention and the processes for the preparation thereof makes the Metsulfuron methyl active content more stable even in the presence of Clodinafop propargyl active ingredient at a pH range of 4 to 9. It has been found that coating the Metsulfuron methyl with coating agents such as herein described and preferably like modified silicone di-oxide, hydrophobic inert material provides a stabilized Metsulfuron methyl active ingredient even at the pH equals to the pH of Clodinafop propargyl 15% WP. Therefore, from the above tables 1, 2 and 3 it is evident that only the compositions according to the present invention with selected coating agents is satisfactory for formulating the invented herbicidal composition; possessing the necessary desirable properties for successful herbicidal effect.

### Shelf Life Stability of the Preferred Compositions:

The study was conducted to determine the storage stability in real of compositions according to the present invention i.e. 16% WP in trilaminated aluminium pouch at ambient temperature for a period of two and a half year (30 months). The test substance was prepared in duplicate and labeled as Sample-1 and Sample-2. The labeled pouches were kept at ambient temperature at three locations after 3, 6, 12, 15, 18, 24 and 30 months after manufacturing and analysed as per the method decided.

Ten containers of the same composition as the commercial container (packed in trilaminated aluminum pouch) having 500 g of test substance and two extra containers (for emergency purpose) of the test substance were stored at ambient temperature for 30 months (i.e. 24 months and 6 months extra). One pouch of each sample of the test substance was drawn initially (zero day), after 3, 6, 12, 15, 18, 24 and 30 months of storage from all three locations and analyzed within 7 days of scheduled time of analysis. The period of 7 days was kept to eliminate the time lapse in delivering the samples to the analytical site. The test substance was evaluated for appearance of test substance, active ingredient content (as Clodinafop-propargyl and as Metsulfuron methyl), Wettability, suspensibility, wet sieve test and acidity content of test substance.

### Appearance

The colour and physical state of the test substance was recorded at room temperature by visual inspection and description of colour or lack of colour was reported qualitatively.

### Active Ingredient Determination

The active ingredient Clodinafop propargyl and Metsulfuron methyl content was determined by using their respective AOAC methods of analysis.

### Wettability or Wetting Time of the Material (CIPAC MT 53.3.1)

A volume of 100 mL standard water D (prepared as per CIPAC MT 18.1.4) was taken into a beaker of 250 mL capacity. Quantities of test substance (approximately 5 g) for 0 day, after 3, 6, 9, 12 and 18 months of storage were weighed (Refer Table 15) for replication I and II, respectively, with care that test substance remains in a non-compact form. It was then added at once, by dropping it on the water from a position level with the rim of the beaker, without undue agitation of the liquid surface and the stopwatch was started simultaneously. The time taken for complete wetting of test substance (neglect a film of fine particles remaining on the surface) was recorded. Time was reported to the nearest second, required for complete wetting of the test substance as the wetting time.

### Suspensibility: Methodology for Suspensibility (CIPAC MT 168)

Preparation of the Suspension without Creaming

Different quantities of test substance [calculated from the recommended dose (133.0 g of a.i. per hectare in 200 L water)] for 0 day, after 3, 6, 9, 12 and 18 months of storage were weighed (Refer Table 11) for replication I and II, respectively and transferred slowly into separate beaker, containing 50 mL standard water D (prepared as per CIPAC MT 18.1.4) at 30±1° C. The contents were swirled by hand in a circular motion at the rate of 120 cycle/minute for a period of 2 minutes. The suspension was then kept undisturbed for 4 minutes in a water bath maintained at 30±1° C.

### Determination of Sedimentation

The above suspension was transferred quantitatively into separate measuring cylinders of 250 mL capacity each at 30±1° C. The volume was made unto the mark with standard water D at 30±1° C. and the stopper was inserted. The cylinders were inverted 30 times for a period of 1 minute, through 180 degree and back again (time for 1 invert=2 seconds approximately). The cylinders were placed in the water bath at a temperature of 30±1° C. in an upright position free from vibration and not in direct sunlight for a period of 30 minutes. After 30 minutes, 225 mL ( 9/10^{th}) of the content from each of the cylinders was removed using suction tube in 10 to 15 seconds with taking care not to shake or stir up the sediment in the cylinders. The tip of the tube was kept a few mm below the surface of the liquid ( 1/10^{th}). The remaining 25 mL suspension was transferred quantitatively to separate pre-weighed glass discs with a jet of distilled water from the wash bottle. The discs were dried to a constant mass in hot-air-oven at 70° C. After drying the residue, the discs were taken out from the oven and residue was weighed (a).

### Calculation of Suspensibility

Suspensibility was calculated using the following formula:

$$Suspensibility ( \% ) = 111 ( 1 - \frac{a}{w} )$$

where,
   a=The weight (g) of the dried residue remaining on 25 mL of suspension
   w=The weight (g) of the sample taken
      Wet sieve test: Methodology for Wet Sieve Test (CIPAC MT 167)

### Wetting of Test Substance

Quantities of test substance (approximately 10 g) for 0 day, after 3, 6, 9, 12 and 18 months of storage were weighed (Refer Table 14) for replication 1 and 11, respectively, into beaker of 250 mL capacity. A volume of 100 mL tap water (5-15° C.) was added into each of the beakers and was allowed to stand for 60 seconds. After 60 seconds, the slurry was stirred with a rubber capped glass rod by hand in a three to four revolutions per second for 30 seconds.

### Wet Sieving

The above slurry was transferred quantitatively to the 75 μm sieve. The residue in the beaker and glass rod was rinsed with water and the slurry on the sieve was rinsed with tap water using rubber hose at the rate of 4 to 5 liter/min. This was continued for 10 minutes. The water was directed on the sieve from the circumference towards the center of the sieve in a circular manner. About 2-5 cm distance was maintained between the rubber hose and the surface of the sieve. After 10 minutes, 100% material passed through the test sieve.

### Acidity: Electrometric Method for Acidity/Alkalinity (CIPAC MT 191)

A quantity of 10±0.01 g test substance was taken in a beaker. A volume of 100 mL distilled water was added into the beaker and the contents were stirred properly to homogenize the mixture. The contents were stirred and titrated electrometrically with 0.02N NaOH solution (t mL) or 0.02N HCl solution (s mL) to pH 7. The experiment was conducted in three replicates and mean value along with standard deviation was reported.

### Calculation

$$Acidity , calculated as {H}_{2} {SO}_{4} ( \% , m / m ) = \frac{4.904 \times {c}_{i} \times t}{w}$$

where,
   cₜ=Normality of NaOH solution; t=Volume (mL) of NaOH solution consumed
   w=Weight (g) of the test substance
      The results of analyses are summarized below:

TABLE 4
Shows the summary of results for shelf life of sample - 1 kept at Location 1
(upto 30 months)
Location Sample-1

| | | | Result after ambient storage of | | | | | | | |
|---|---|---|---|---|---|---|---|---|---|---|
| S. No | Parameter | Specification | 0 day | 3 month | 6 month | 12 month | 15 month | 18 month | 24 month | 30 month |
| 1 | Appearance | — | White to off-white free flowing powder, free from hard lumps | | | | | | | |
| 2 | Clodinafop | 14.25-15.75 | 15.320 | 15.298 | 15.278 | 15.191 | 15.153 | 15.048 | 15.045 | 14.988 |
| | propargyl | | | | | | | | | |
| | Content (% | | | | | | | | | |
| | by mass) | | | | | | | | | |
| 3 | Metsulfuron | 0.95-1.10 | 1.093 | 1.091 | 1.082 | 1.081 | 1.070 | 1.064 | 1.058 | 1.043 |
| | methyl | | | | | | | | | |
| | Content (% | | | | | | | | | |
| | by mass) | | | | | | | | | |
| 4 | Wettability | 120 Maximum | 50 | 52.5 | 54.5 | 57 | 59.5 | 64 | 69 | 73 |
| | (in seconds) | | | | | | | | | |
| 5 | Suspensibility | 60 Minimum | 91.43 | 90.283 | 89.045 | 88.29 | 86.218 | 83.888 | 82.833 | 81.075 |
| | (% by mass) | | | | | | | | | |
| 6 | Wet sieve test | 98 Minimum | 99.70 | 99.595 | 99.42 | 99.165 | 98.88 | 98.695 | 98.445 | 98.185 |
| | (% by mass, | | | | | | | | | |
| | passing | | | | | | | | | |
| | through 75μ | | | | | | | | | |
| | test sieve) | | | | | | | | | |
| 7 | Acidity (as | 0.5 Maximum | 0.010 | 0.0125 | 0.015 | 0.017 | 0.0155 | 0.018 | 0.020 | 0.022 |
| | H₂SO₄ % by | | | | | | | | | |
| | mass) | | | | | | | | | |

TABLE 5
Shows the summary of results for shelf life of sample - 2 kept at location 1
(upto 30 months)
Location 1 Sample-2

| | | | Result after ambient storage of | | | | | | | |
|---|---|---|---|---|---|---|---|---|---|---|
| S. No | Parameter | Specification | 0 day | 3 month | 6 month | 12 month | 15 month | 18 month | 24 month | 30 month |
| 1 | Appearance | — | White to off-white free flowing powder, free from hard lumps | | | | | | | |
| 2 | Clodinafop | 14.25-15.75 | 15.465 | 15.451 | 15.413 | 15.369 | 15.299 | 15.248 | 15.149 | 15.066 |
| | propargyl | | | | | | | | | |
| | Content (% | | | | | | | | | |
| | by mass) | | | | | | | | | |
| 3 | Metsulfuron | 0.95-1.10 | 1.072 | 1.069 | 1.067 | 1.058 | 1.0525 | 1.046 | 1.035 | 1.027 |
| | methyl | | | | | | | | | |
| | Content (% | | | | | | | | | |
| | by mass) | | | | | | | | | |
| 4 | Wettability | 120 Maximum | 51.5 | 53.5 | 55.5 | 56.50 | 62 | 63.5 | 69.5 | 77 |
| | (in seconds) | | | | | | | | | |
| 5 | Suspensibility | 60 Minimum | 92.91 | 92.165 | 90.565 | 88.553 | 87.158 | 85.483 | 84.008 | 81.468 |
| | (% by mass) | | | | | | | | | |
| 6 | Wet sieve test | 98 Minimum | 99.735 | 99.60 | 99.485 | 99.35 | 99.17 | 98.99 | 98.775 | 98.555 |
| | (% by mass, | | | | | | | | | |
| | passing | | | | | | | | | |
| | through 75μ | | | | | | | | | |
| | test sieve) | | | | | | | | | |
| 7 | Acidity (as | 0.5 Maximum | 0.011 | 0.012 | 0.014 | 0.018 | 0.021 | 0.021 | 0.025 | 0.028 |
| | H₂SO₄ | | | | | | | | | |
| | % by mass) | | | | | | | | | |

TABLE 6
Shows the summary of results for shelf life of sample - 1 kept at location 2
(upto 30 months)
Location 2 Sample-1

| | | | Result after ambient storage of | | | | | | | |
|---|---|---|---|---|---|---|---|---|---|---|
| S. No | Parameter | Specification | 0 day | 3 month | 6 month | 12 month | 15 month | 18 month | 24 month | 30 month |
| 1 | Appearance | — | White to off-white free flowing powder, free from hard lumps | | | | | | | |
| 2 | Clodinafop | 14.25-15.75 | 15.320 | 15.308 | 15.259 | 15.209 | 15.119 | 15.098 | 15.026 | 14.960 |
| | propargyl | | | | | | | | | |
| | Content (% | | | | | | | | | |
| | by mass) | | | | | | | | | |
| 3 | Metsulfuron | 0.95-1.10 | 1.093 | 1.090 | 1.086 | 1.081 | 1.073 | 1.068 | 1.055 | 1.045 |
| | methyl | | | | | | | | | |
| | Content (% | | | | | | | | | |
| | by mass) | | | | | | | | | |
| 4 | Wettability | 120 Maximum | 50 | 51.5 | 53 | 55.5 | 60 | 63.5 | 66.5 | 72.5 |
| | (in seconds) | | | | | | | | | |
| 5 | Suspensibility | 60 Minimum | 91.43 | 90.513 | 89.200 | 87.258 | 86.153 | 84.655 | 82.893 | 81.903 |
| | (% by mass) | | | | | | | | | |
| 6 | Wet sieve test | 98 Minimum | 99.70 | 99.595 | 99.425 | 99.15 | 98.955 | 98.78 | 98.475 | 98.25 |
| | (% by mass, | | | | | | | | | |
| | passing | | | | | | | | | |
| | through 75μ | | | | | | | | | |
| | test sieve) | | | | | | | | | |
| 7 | Acidity (as | 0.5 Maximum | 0.010 | 0.012 | 0.015 | 0.016 | 0.0175 | 0.019 | 0.021 | 0.023 |
| | H₂SO₄ | | | | | | | | | |
| | % by mass) | | | | | | | | | |

TABLE 7
Shows the summary of results for shelf life of sample - 2 kept at location 2
(upto 30 months)
Location 2 Sample-2

| | | | Result after ambient storage of | | | | | | | |
|---|---|---|---|---|---|---|---|---|---|---|
| S. No | Parameter | Specification | 0 day | 3 month | 6 month | 12 month | 15 month | 18 month | 24 month | 30 month |
| 1 | Appearance | — | White to off-white free flowing powder, free from hard lumps | | | | | | | |
| 2 | Clodinafop | 14.25-15.75 | 15.465 | 15.455 | 15.432 | 15.336 | 15.294 | 15.248 | 15.165 | 15.074 |
| | propargyl | | | | | | | | | |
| | Content (% | | | | | | | | | |
| | by mass) | | | | | | | | | |
| 3 | Metsulfuron | 0.95-1.10 | 1.072 | 1.070 | 1.068 | 1.0605 | 1.052 | 1.047 | 1.040 | 1.027 |
| | methyl | | | | | | | | | |
| | Content (% | | | | | | | | | |
| | by mass) | | | | | | | | | |
| 4 | Wettability | 120 Maximum | 51.5 | 52.5 | 54 | 57.5 | 61.5 | 66.5 | 72.5 | 77.5 |
| | (in seconds) | | | | | | | | | |
| 5 | Suspensibility | 60 Minimum | 92.91 | 92.425 | 90.810 | 88.833 | 86.608 | 85.11 | 83.743 | 81.225 |
| | (% by mass) | | | | | | | | | |
| 6 | Wet sieve test | 98 Minimum | 99.735 | 99.645 | 99.52 | 99.315 | 99.14 | 98.97 | 98.81 | 98.50 |
| | (% by mass, | | | | | | | | | |
| | passing | | | | | | | | | |
| | through 75μ | | | | | | | | | |
| | test sieve) | | | | | | | | | |
| 7 | Acidity (as | 0.5 Maximum | 0.011 | 0.012 | 0.016 | 0.017 | 0.019 | 0.022 | 0.026 | 0.028 |
| | H₂SO₄ | | | | | | | | | |
| | % by mass) | | | | | | | | | |

TABLE 8
Shows the summary of results for shelf life of sample - 1 kept at location 3
(upto 30 months)
Location 3 Sample-1

| | | | Result after ambient storage of | | | | | | | |
|---|---|---|---|---|---|---|---|---|---|---|
| S. No | Parameter | Specification | 0 day | 3 month | 6 month | 12 month | 15 month | 18 month | 24 month | 30 month |
| 1 | Appearance | — | White to off-white free flowing powder, free from hard lumps | | | | | | | |
| 2 | Clodinafop | 14.25-15.75 | 15.320 | 15.315 | 15.254 | 15.207 | 15.144 | 15.082 | 15.007 | 14.957 |
| | propargyl | | | | | | | | | |
| | Content (% | | | | | | | | | |
| | by mass) | | | | | | | | | |
| 3 | Metsulfuron | 0.95-1.10 | 1.093 | 1.091 | 1.087 | 1.079 | 1.072 | 1.067 | 1.055 | 1.046 |
| | methyl | | | | | | | | | |
| | Content (% | | | | | | | | | |
| | by mass) | | | | | | | | | |
| 4 | Wettability | 120 Maximum | 50 | 51.5 | 55 | 55.5 | 59 | 65 | 68.5 | 71 |
| | (in seconds) | | | | | | | | | |
| 5 | Suspensibility | 60 Minimum | 91.43 | 90.085 | 89.195 | 88.243 | 85.635 | 84.505 | 82.673 | 81.293 |
| | (% by mass) | | | | | | | | | |
| 6 | Wet sieve test | 98 Minimum | 99.70 | 99.56 | 99.46 | 99.08 | 98.905 | 98.725 | 98.43 | 98.295 |
| | (% by mass, | | | | | | | | | |
| | passing | | | | | | | | | |
| | through 75μ | | | | | | | | | |
| | test sieve) | | | | | | | | | |
| 7 | Acidity (as | 0.5 Maximum | 0.010 | 0.012 | 0.0155 | 0.017 | 0.017 | 0.0195 | 0.018 | 0.021 |
| | H₂SO₄ | | | | | | | | | |
| | % by mass) | | | | | | | | | |

TABLE 9
Shows the summary of results for shelf life of sample - 2 kept at Location
3 (upto 30 months).
Location 3 Sample-2

| | | | Result after ambient storage of | | | | | | | |
|---|---|---|---|---|---|---|---|---|---|---|
| S. No | Parameter | Specification | 0 day | 3 month | 6 month | 12 month | 15 month | 18 month | 24 month | 30 month |
| 1 | Appearance | — | White to off-white free flowing powder, free from hard lumps | | | | | | | |
| 2 | Clodinafop | 14.25-15.75 | 15.465 | 15.449 | 15.437 | 15.344 | 15.294 | 15.221 | 15.159 | 15.044 |
| | propargyl | | | | | | | | | |
| | Content (% | | | | | | | | | |
| | by mass) | | | | | | | | | |
| 3 | Metsulfuron | 0.95-1.10 | 1.072 | 1.070 | 1.067 | 1.060 | 1.052 | 1.045 | 1.036 | 1.025 |
| | methyl | | | | | | | | | |
| | Content (% | | | | | | | | | |
| | by mass) | | | | | | | | | |
| 4 | Wettability | 120 Maximum | 51.5 | 50.5 | 53.5 | 57.5 | 60 | 66.5 | 70.5 | 79 |
| | (in seconds) | | | | | | | | | |
| 5 | Suspensibility | 60 Minimum | 92.91 | 93.218 | 90.608 | 88.228 | 87.295 | 85.498 | 83.673 | 81.77 |
| | (% by mass) | | | | | | | | | |
| 6 | Wet sieve test | 98 Minimum | 99.735 | 99.60 | 99.49 | 99.315 | 99.155 | 98.97 | 98.80 | 98.54 |
| | (% by mass, | | | | | | | | | |
| | passing | | | | | | | | | |
| | through 75μ | | | | | | | | | |
| | test sieve) | | | | | | | | | |
| 7 | Acidity (as | 0.5 Maximum | 0.011 | 0.012 | 0.016 | 0.017 | 0.021 | 0.022 | 0.025 | 0.028 |
| | H₂SO₄ | | | | | | | | | |
| | % by mass) | | | | | | | | | |

### Conclusion:

The data revealed that the 16% WP (Clodinafop-propargyl 15%+Metsulfuron methyl 1%) compositions according to the present invention were stable under ambient condition of the storage for a period of 30 months. The test substance showed no significant changes in physical and chemical properties viz., appearance of test substance, active ingredient content (as Clodinafop-propargyl and as Metsulfuron methyl), Wettability, suspensibility, wet sieve test and acidity content of test substance.

### Field Trial

The invention will now be explained in more detail in the following examples that illustrate, but are not intended to limit, the invention.

Parts and percentages are by weight unless otherwise indicated. Field tests were made at various trial sites. The performance of the new combination herbicide according to the present invention (Clodinafop 15% and metsulfuron methyl 1%), Metsulfuron methyl 20% WP and Clodinafop-propargyl 15% WP was evaluated against weed flora in wheat crop during rabi season. Recommended package of practices for wheat crop was followed to raise the crop. The herbicide treatments were applied as post emergence spray at 35 days after sowing (DAS). The data on weed population (number/m²) and dry matter (gm/m²) was taken after 60 days after sowing and at the harvest. Similar yields (quintal/hectare i.e. q/ha.) and yield attributed parameters like plant height, number of effective tiller, number of grain per ear-head, test weight were recorded at harvest. A statistical analysis of the entire data was carried out.

Phytotoxicity studies were also conducted on a rating scale of 0-10 for treatments of Clodinafop 15%+Metsulfuron methyl 1% 16% WP@320 gm/acre (double the recommended dose) and Metsulfuron methyl 20% WP@16 gm/acre (double the recommended dose).

The major weed flora recorded in the experimental field were grasses like Phalaris minor and Avena fatua and broad leaf weeds namely Chenopodium album, Rumex sp., Convolvulus arvensis, Melilotus alba, Medicago denticulata, Fumaria sp. Vicia sativa and Anagalis arvensis.

Comparative substances or compositions used in the tests and believed to be representative of the best prior art weed control agents for use and were:

(A) Clodinafop propargyl 15% WP
(B) Metsulfuron methyl 20% WP (Algrip) Market sample
(C) Metsulfuron methyl 20% WP
(D) Compositions according to the present invention (16% WP)

The results of several representative tests are enumerated below in Tables

Table II provides the details of treatments used during experimental trials in 2005-2006

| | | | | Volume of | Time of |
|---|---|---|---|---|---|
| | | Formulation | Surfactant | water used | application |
| No. | Treatment | Dose (g/acre) | used (ml/acre) | (L/acre) | (DAS) |
| 1 | Untreated Control | — | — | — | — |
| 2 | Clodinafop | 160 | — | 150 | 30 |
| | propargyl 15% WP | | | | |
| 3 | Metsulfuron | 8 | 250 | 200 | 30 |
| | methyl 20% WP | | | | |
| | (A) | | | | |
| 4 | Metsulfuron | 6 | 250 | 200 | 30 |
| | methyl 20% WP | | | | |
| | (B) | | | | |
| 5 | Metsulfuron | 8 | 250 | 200 | 30 |
| | methyl 20% WP | | | | |
| | (C) | | | | |
| 6 | Metsulfuron | 10 | 250 | 200 | 30 |
| | methyl 20% WP | | | | |
| | (D) | | | | |
| 7 | 16% WP | 120 | 500 | 150 | 40 |
| 8 | 16% WP | 160 | 500 | 150 | 40 |
| 9 | 16% WP | 200 | 500 | 150 | 40 |
| 10 | Manual weeding | — | — | — | — |
| 11 | Weedy check | — | — | — | — |

The results in table 12 and 13 concludes that the applications of all herbicides significantly reduced the weeds population and dry matters of weeds recorded at 60 DAS and at harvest as compared to untreated check. The 16% WP compositions according to the present invention @200 g/acre was at par with its lower dose @160 g/acre and Clodinafop propargyl 15% WP@160 g/acre and found very effective in reducing grassy weeds as well as broad leaf weeds populations and biomass as compared to rest of the treatment.

TABLE 12
Shows the average weed population/m² of grasses and broad leaf weeds in
untreated control plot and that in treated plots by different herbicide
treatment after 60 days of sowing and at the time of harvesting.

| | | Weed population/m2 | | | |
|---|---|---|---|---|---|
| | Formulation | 60 days | | At Harvest | |
| | Dose (g or | Grassy | Broad leaf | Grassy | Broad leaf |
| Treatment | ml/acre) | weeds | weeds | weeds | weeds |
| Untreated Control | — | 69.6 | 119.3 | 61.3 | 128.6 |
| | | (9.34)* | (11.92) | (8.83) | (12.34) |
| Clodinafop propargyl | 160 | 3.0 | 114.6 | 2.6 | 124.3 |
| 15% WP | | (2.73) | (11.71) | (2.61) | (12.15) |
| Metsulfuron methyl 20% | 8 | 67.0 | 4.6 | 63.3 | 5.0 |
| WP (A) | | (9.19) | (3.14) | (8.96) | (3.24) |
| Metsulfuron methyl 20% | 6 | 71.3 | 7.6 | 60.0 | 9.0 |
| WP (B) | | (9.44) | (3.76) | (8.75) | (4.00) |
| Metsulfuron methyl 20% | 8 | 65.0 | 5.0 | 62.0 | 5.0 |
| WP (C) | | (9.06) | (3.24) | (8.87) | (3.24) |
| Metsulfuron methyl 20% | 10 | 68.6 | 4.0 | 65.6 | 4.6 |
| WP (D) | | (9.28) | (3.00) | (9.10) | (3.14) |
| 16% WP | 120 | 4.3 | 6.0 | 4.0 | 7.6 |
| | | (3.07) | (3.45) | (3.00) | (3.76) |
| 16% WP | 160 | 2.6 | 3.6 | 2.0 | 4.6 |
| | | (2.61) | (2.90) | (2.41) | (3.14) |
| 16% WP | 200 | 2.0 | 3.6 | 1.6 | 4.0 |
| | | (2.41) | (2.90) | (2.26) | (3.00) |

*= data in parenthesis are (square root) + 1 value.

TABLE 13
Shows the weed biomass (g/m²) of grasses and broad leaf
weeds in untreated control plot and that in treated plots by different
herbicide treatment after 60 days of sowing and at the time of
harvesting.

| | | Weed biomass (g/m²) | | | |
|---|---|---|---|---|---|
| | | 60 days | | At Harvest | |
| | Formulation | | Broad | | Broad |
| | Dose (g or ml/ | Grassy | leaf | Grassy | leaf |
| Treatment | acre) | weeds | weeds | weeds | weeds |
| Untreated control | — | 109.36 | 150.88 | 122.38 | 198.33 |
| Clodinafop propargyl 15% | 160 | 5.80 | 163.36 | 6.76 | 297.76 |
| WP | | | | | |
| Metsulfuron methyl 20% | 8 | 117.20 | 4.86 | 164.58 | 7.4 |
| WP (A) | | | | | |
| Metsulfuron methyl 20% | 6 | 124..08 | 6.16 | 159.00 | 12.80 |
| WP (B) | | | | | |
| Metsulfuron methyl 20% | 8 | 114.00 | 4.96 | 161.20 | 7.00 |
| WP (C) | | | | | |
| Metsulfuron methyl 20% | 10 | 119.76 | 4.10 | 155.56 | 6.12 |
| WP (D) | | | | | |
| 16% WP | 120 | 5.88 | 5.60 | 7.40 | 10.32 |
| 16% WP | 160 | 3.46 | 4.18 | 5.20 | 6.72 |
| 16% WP | 200 | 3.20 | 3.70 | 4.36 | 5.80 |
| CD (p = 0.05) | — | 2.65 | 1.34 | 3.98 | 3.15 |

The results and observations in the following table-14 revealed that treatments with herbicide significantly increased the number of effective tillers/m row length, ear head, test weight and yield of wheat over untreated check. The treatment with 16% WP@200 and 160 g/acre, which were at par with each other, resulted in significant higher number of effective tillers/m row length, number of seed/ear head and test weight and therefore, increased grain yield as compared to rest of the treatments.

TABLE 14
Shows the effect of herbicides on yield attributed parameters of wheat at
harvest

| | Formulation | | No. of | | | |
|---|---|---|---|---|---|---|
| | Dose | | effective | No. of | | |
| | (g or | Plant | tiller/m | grain/ | Test | |
| | ml/ | height | row | ear- | weight | Yield |
| Treatment | acre) | (cm) | length | head | (gm) | (q/ha.) |
| Untreated control | — | 89.12 | 72.67 | 23.69 | 36.56 | 27.71 |
| Clodinafop propargyl | 160 | 89.00 | 91.67 | 29.78 | 40.10 | 41.12 |
| 15% WP | | | | | | |
| Metsulfuron methyl | 8 | 88.87 | 90.33 | 28.12 | 40.15 | 40.23 |
| 20% WP (A) | | | | | | |
| Metsulfuron methyl | 6 | 88.10 | 88.67 | 28.64 | 39.73 | 37.48 |
| 20% WP (B) | | | | | | |
| Metsulfuron methyl | 8 | 88.02 | 89.33 | 29.00 | 39.84 | 39.46 |
| 20% WP (C) | | | | | | |
| Metsulfuron methyl | 10 | 88.22 | 90.00 | 28.87 | 40.00 | 41.13 |
| 20% WP (D) | | | | | | |
| 16% WP | 120 | 88.62 | 94.33 | 30.11 | 40.56 | 44.07 |
| 16% WP | 160 | 89.10 | 97.67 | 31.14 | 41.13 | 46.15 |
| 16% WP | 200 | 89.14 | 98.00 | 31.54 | 41.24 | 46.00 |
| CD (p = 0.05) | — | NS | 6.78 | 1.81 | N.S. | 1.10 |

Separate treatments were kept for studying the phytotoxicity of 16% WP@160 and 320 g/acre. The parameters of phytotoxicity if any were yellowing, scorching, necrosis, epinasty and hyponasty. The observations were recorded at the intervals of 3, 7 and 21 days after application. 0-10 rating scale was used for observing phytotoxicity symptoms if any 0 shows no phytotoxicity symptoms and 10 shows highly phytotoxic.

TABLE 15
Shows the effect of different herbicidal treatments on
phytotoxicity (on wheat crop at 3, 7 and 21 DAT*)

| | Treatment of 16% WP* | | | | |
|---|---|---|---|---|---|
| S. | Formulation Dose (g or | Observed | Observed on | | |
| No. | mL/acre) | for | 3 DAT | 7 DAT | 21 DAT |
| 1 | 160 | Yellowing | 0 | 0 | 0 |
| | | Necrosis | 0 | 0 | 0 |
| | | Scorching | 0 | 0 | 0 |
| | | Epinasty | 0 | 0 | 0 |
| | | Hyponasty | 0 | 0 | 0 |
| 2 | 320 | Yellowing | 0 | 0 | 0 |
| | | Necrosis | 0 | 0 | 0 |
| | | Scorching | 0 | 0 | 0 |
| | | Epinasty | 0 | 0 | 0 |
| | | Hyponasty | 0 | 0 | 0 |

*DAT: Days After Treatment

Application of all herbicides significantly reduced the weeds population and dry matters of weeds recorded at 60 DAS and at harvest as compared to the untreated check. 16% WP@200 gm/acre and Clodinafop-propargyl 15% WP@160 gm/acre was found very effective in reducing grassy weed populations and biomass as compared to rest of the treatments. The least effective treatments were Metsulfuron methyl 20% WP at all the dosages.

Table 12 and 13 indicate that 16% WP@200 gm/acre was found at par with its lower dose @160 gm/acre and Metsulfuron methyl 20% WP@10 and 8 gm/acre in reducing both population and dry weight of broad leaf weeds recorded at 60 DAS and at harvest stage of wheat. Clodinafop-propargyl 15% WP@160 gm/acre was the least effective of all.

Table 14 revealed that the treatments with 16% WP@200 and 160 gm/acre resulted in significant higher number of effective tillers/m row length, number of seed/ear head and test weight and therefore, increased grain yield as compared to the rest of the treatments.

Table 15 provides that there was no phytotoxicity symptoms observed in case of 16% WP even at the rate of 320 gm/acre (or 800 g/ha) and 16 gm/acre (or 40 g/ha) respectively at any stage of crop growth.

Conclusion: The above data surprisingly brings out 16% WP@160 gm/acre as the most effective and ideal treatment in controlling complex weed flora in wheat. The superiority of the treatment is clearly depicted in the lowest weed population, dry weight of weeds and highest grain yield. The data clearly shows that metsulfuron methyl gave superior control of broad leaf weeds only.

Another field trial was conducted during Rabi season to evaluate the bio-efficacy of various doses of the combination of Clodinafop propargyl and metsulfuron methyl against complex weed flora of Wheat. All the herbicides were applied 30-40 days after sowing. Observation on weed population and dry weight of weeds per sq mtr were taken at 60 days after sowing. Spikes per sq mtr were also counted. Grain yield (kg/ha) was recorded at the time of harvesting. The data was also evaluated statistically.

TABLE 16
Shows the effect of 16% WP and Metsulfuron methyl 20% WP (MSM) on
weeds in wheat with additional surfactant quantity during use.

| | | Time of | Weed population (Number/mtr²) at 60 DAS | | | | | | | |
|---|---|---|---|---|---|---|---|---|---|---|
| | Dose | application | | | | Melilotus | | | | |
| Treatment | (g/ha) | (DAS) | P. minor | A. fatua | C. album | spp. | M. denticulate | V. Sativa | R. acetosella | Others |
| MSM | 20 | 30 | 211 | 8 | 0 | 0 | 1 | 0 | 0 | 1 |
| Market) + | | | | | | | | | | |
| Surfactant | | | | | | | | | | |
| MSM | 15 | 30 | 224 | 7 | 3 | 3 | 3 | 0 | 1 | 8 |
| (UPL) + | | | | | | | | | | |
| Surfactant | | | | | | | | | | |
| MSM | 20 | 30 | 201 | 9 | 0 | 0 | 1 | 0 | 0 | 1 |
| (UPL) + | | | | | | | | | | |
| Surfactant | | | | | | | | | | |
| MSM | 25 | 30 | 216 | 8 | 0 | 0 | 0 | 0 | 0 | 0 |
| (UPL) + | | | | | | | | | | |
| Surfactant | | | | | | | | | | |
| 16% WP + | 300 | 40 | 5 | 3 | 0 | 3 | 4 | 3 | 4 | 12 |
| Surfactant | | | | | | | | | | |
| 16% WP + | 400 | 40 | 2 | 1 | 0 | 0 | 1 | 1 | 1 | 2 |
| Surfactant | | | | | | | | | | |
| 16% WP + | 500 | 40 | 1 | 0 | 0 | 0 | 1 | 1 | 0 | 1 |
| Surfactant | | | | | | | | | | |
| Clodinafop | 400 | 30 | 7 | 3 | 23 | 17 | 19 | 8 | 11 | 36 |
| propargyl | | | | | | | | | | |
| Manual | — | 35 & 55 | 0 | 0 | 0 | 0 | 0 | 0 | 0 | 0 |
| weeding | | | | | | | | | | |
| Weedy | — | — | 215 | 9 | 25 | 15 | 16 | 9 | 9 | 32 |
| check | | | | | | | | | | |

DAS—Days after sowing
Others: include Anagalis arvensis, Coronopus didymus, Fumaria parviflor and Polygonum spp.

The observations were made on weeds like Phalaris minor, Avena fatua, Chenopodium album, Melilotus spp., Medicago denticulate, Vicia sativa, Rumes acetosella and other weeds such as Anagalis arvensis, Coronopus didymus, Fumaria parviflor and Polygonum spp. were found in the weedy check at 60 DAS (table 16). MSM at all the rates except MSM@15 g/ha along with surfactant provided effective control of all the broad-leaved weeds namely C. album, Melilotus spp., M. denticulate, V. sativa, R acetosella and other weeds. The herbicide MSM was not effective against Phalaris minor and Avena fatua. 16% WP@300 g/ha along with surfactant provided very good control of Phalaris minor, Avena fatua and all the broad leaved weeds. The efficacy of this herbicide increased with the increase of its rate of application. Almost complete control of grasses and broad leaved weeds was observed with the application of 16% WP@400 g/ha and 500 g/ha. The weed control spectrum and efficiency of the innovative combination @400 g/ha and 500 g/ha (with surfactant) was the best and at par with each other. Both the doses @400 g/ha and 500 g/ha were comparable.

TABLE 17
Shows the effect of 16% WP and Metsulfuron methyl 20%
WP (MSM) on weed dry weight, number of spikes and grain
yield of wheat with additional surfactant quantity during use.

| | | | Total | | |
|---|---|---|---|---|---|
| | | | weed dry | | |
| | | | weigh | | |
| | | Time of | (g/mtr²) | | Grain |
| | Dose | application | at 60 | Spikes/ | yield |
| Treatment | (g/ha) | (DAS) | DAS | mtr² | (kg/ha) |
| MSM (Algrip) + | 20 | 30 | 167.8 | 289 | 2720 |
| Surfactant | | | | | |
| MSM (UPL) + | 15 | 30 | 178.3 | 276 | 2540 |
| Surfactant | | | | | |
| MSM (UPL) + | 20 | 30 | 163.3 | 286 | 2752 |
| Surfactant | | | | | |
| MSM (UPL) + | 25 | 30 | 170.0 | 283 | 2690 |
| Surfactant | | | | | |
| 16% WP + | 300 | 40 | 12.0 | 371 | 3980 |
| Surfactant | | | | | |
| 16% WP + | 400 | 40 | 7.3 | 380 | 4082 |
| Surfactant | | | | | |
| 16% WP + | 500 | 40 | 3.2 | 374 | 4050 |
| Surfactant | | | | | |
| Clodinafop | 400 | 30 | 72.5 | 327 | 3400 |
| propargyl | | | | | |
| Manual weeding | — | 35 & 55 | 0.0 | 368 | 4095 |
| Weedy check | — | — | 228.0 | 189 | 1525 |
| S. Em± | — | — | 9.2 | 5 | 97 |
| C.D. at 5% | — | — | 26.7 | 14 | 282 |

Note:
16% WP stands for composition of Clodinafop propargyl (15%) + Metsulfuron methyl (1%) made according to the present invention.

The above table 17, shows that the wheat grain yield (Kg/ha) with 16% WP@300 g/ha along with surfactant is 3980. The grain yield was found to be increased with the increase of 16% WP along with surfactant rate of application i.e. 400 and 500 g/ha respectively providing the grain yield 4082 and 4050 Kg/ha. The grain yield of the 16% WP combination @400 g/ha and 500 g/ha (with surfactant) was the best and at par with each other. Grain yield in Kg/ha for both the doses @400 g/ha and 500 g/ha were comparable.

The combination of ingredients Clodinafop propargyl+Metsulfuron methyl shows a clearly super-additive complementation of effects over those of the individual ingredients Clodinafop propargyl, Metsulfuron methyl applied separately.

The herbicidal compositions prepared by the process according to the present invention are preferably in the form of concentrated products. In practice, the amounts of the herbicidal composition to be used is between 0.001 kg/ha and 2 kg/ha, preferably between 0.01 to 1 kg/ha. The formulated agricultural herbicidal products which are prepared according to the process of the proposed invention, which are diluted by the agriculturalists in containers which contain water for application. These diluted mixtures are usually applied at 50 to 1500 L/ha.

Conclusion: Field tests of the compositions according to the present invention were made at various controlled trial sites. The performance of the combination herbicide according to the present invention (Clodinafop propargyl 15%+Metsulfuron methyl 1%) was compared against the known compositions of Metsulfuron methyl 20% WP (wettable powders) and Clodinafop-propargyl 15% WP (wettable powders), which were evaluated against weed flora in wheat crop during rabi season. The recommended package of practices for wheat crop was followed to raise the crop. The herbicide treatments were applied as post emergence spray at 35 days after sowing (DAS). The data on weed population (number/m²) and dry matter (gm/m²) was taken after 60 days after sowing and at the harvest. Similar yields (q/ha.) and yield attributed parameters like plant height, number of effective tiller, no. of grain per ear-head, test weight were recorded at harvest. A statistical analysis of the entire data was carried out. Phytotoxicity studies were also conducted on a rating scale of 0-10 for treatments of the compositions of the present invention @320 gm/acre (double the recommended dose) and Metsulfuron methyl @16 gm/acre (double the recommended dose). The major weed flora recorded in the experimental field were grasses like Phalaris minor and Avena fatua and broad leaf weeds namely Chenopodium album, Rumex sp., Convolvulus arvensis, Melilotus alba, Medicago denticulata, Fumaria sp. Vicia sativa and Anagalis arvensis.

The trial surprisingly demonstrated that the compositions of the present invention at 160 gm/acre were the most effective and ideal treatment in controlling complex weed flora in wheat. The superiority of the treatment is clearly depicted in the lowest weed population, dry weight of weeds and highest grain yield. The data clearly shows that metsulfuron methyl gave superior control of broad leaf weeds only.

Wherein the aforegoing reference has been made to components having known equivalents, then such equivalents are therein incorporated as if individually set forth. Accordingly, it will be appreciated that changes may be made to the above described aspects and embodiments of the invention without departing from the principles taught herein. Additional advantages of the present invention will become apparent for those skilled in the art after considering the principles in particular form as discussed and illustrated. Thus, it will be understood that the invention is not limited to the particular embodiments described or illustrated, but is intended to cover all alterations or modifications which are within the scope of the appended claims.

1-39. (canceled)

40. A herbicidal composition comprising a first active ingredient being clodinafop-propargyl and a second active ingredient being metsulfuron methyl, wherein said metsulfuron methyl is provided in a particulate form having a substantially homogenous coating of hydrophobic inert material provided thereon.

41. The herbicidal composition as claimed in claim 40, wherein said hydrophobic inert material is selected from a group comprising clays, silica, silicone derivatives, modified cellulose, modified starches, modified silicone dioxide, colloidal silica, precipitated silica, kaolin, china clay, natural waxes, synthetic wax(es), paraffin, paraffin liquid, wax, oils, polymers selected from polyvinyl pyrrolidone, polyvinyl alcohol, gums preferably rosin, stearic acid and mixtures thereof.

42. The herbicidal composition as claimed in claim 41, wherein said hydrophobic inert material is selected from a group comprising modified hydrophobic silicon dioxide, colloidal silica, precipitated silica, hydrophobic silica powder and mixtures thereof.

43. The herbicidal composition as claimed in claim 42, wherein said hydrophobic inert material is hydrophobic silica powder.

44. The herbicidal composition as claimed in claim 40, wherein said particulate metsulfuron methyl has a particle size of about 2 microns to about 200 microns.

45. The herbicidal composition as claimed in claim 44, wherein said particulate metsulfuron methyl has a particle size of less than about 20 microns.

46. The composition as claimed in claim 40, wherein said clodinafop-propargyl active ingredient is present in an amount of from about 0.1 to 50%, preferably 1.0 to 40% and most preferably 2 to 30% by weight of the composition.

47. The composition as claimed in claim 46, wherein said clodinafop-propargyl active ingredient is present in an amount of about 15% by weight of the composition.

48. The composition as claimed in claim 40 wherein said particulate metsulfuron methyl is present in an amount of from about 0.01 to 40%, preferably 0.1% to 35% and most preferably 0.1 to 30% by weight of the composition.

49. A composition as claimed in claim 48, wherein said particulate metsulfuron methyl is present in an amount of about 1% by weight of the composition.

50. The composition as claimed in claim 40 additionally comprising a safener.

51. The composition as claimed in claim 50, wherein said safener is cloquintocet-mexyl.

52. The composition as claimed in claim 50, wherein said safener is present in an amount of about 0.01% to about 25% by weight of the composition.

53. The composition as claimed in claim 40 additionally comprising at least one ingredient selected from a dispersing agent, a wetting, a stabilizer, an inert carrier and mixtures thereof.

54. The composition as claimed in claim 53, wherein said dispersing agent is present in an amount of about 0.1% to about 40%, and preferably from about 1% to about 30% by weight of the composition.

55. The composition as claimed in claim 54, wherein said dispersing agent is selected from the group comprising lignosulphonates, phenyl naphthalene sulphonates, ethoxylated alkyl phenols, ethoxylated fatty acids, alkoxylated linear alcohols, polyaromatic sulfonates, sodium alkyl aryl sulfonates, maleic anhydride copolymers, phosphate esters, condensation products of aryl sulphonic acids and formaldehyde, addition products of ethylene oxide and fatty acid esters, sulfonates of condensed naphthalene, lignin derivatives, naphthalene formaldehyde condensates, polycarboxylates, sodium alkyl benzene sulfonates, salts of sulfonated naphthalene, ammonium salts of sulfonated naphthalene, salts of polyacrylic acids, salts of phenol sulfonic acids and mixtures thereof.

56. The composition as claimed in claim 55, wherein said dispersing agent is sulphated poly aryl alkyl ethoxylate ammonium salt.

57. The composition as claimed in claim 53, wherein said wetting agent is present in an amount of from about 0.5% to about 30% by weight of the composition.

58. The composition as claimed in claim 57, wherein said wetting agent is selected from a group comprising alkyl phenol ethoxylate, fatty oil ethoxylate, phenyl naphthalene sulphonates, alkyl naphthalene sulfonates, sodium alkyl naphthalene sulfonate, sodium salt of sulfonated alkyl carboxylate, polyoxyalkylated ethyl phenols, polyoxyethoxylated fatty alcohols, polyoxyethoxylated fatty amines, lignin derivatives, alkane sulfonates, alkylbenzene sulfonates, salts of polycarboxylic acids, salts of esters of sulfosuccinic acid, alkylnaphthalenesulfonates, alkylbenzenesulfonates, alkylpolyglycol ether sulfonates, alkyl ether phosphates, alkyl ether sulfates and alkyl sulfosuccinic monoesters or mixtures thereof.

59. The composition as claimed in claim 58, wherein said wetting agent is a mixture of ethoxylated alkyl phenol and castor oil ethoxylate in a weight ratio of about 1:10 to about 10:1.

60. The composition as claimed in claim 53, wherein said stabilizer is present in an amount of from about 0.01% to about 20%, preferably from about 0.05% to about 18% by weight of the composition.

61. The composition as claimed in claim 60, wherein said stabilizer is selected from a group comprising epoxidized soybean oil, gamma butyrolactone, butylated hydroxyl toluene and its derivatives, epichlorhydrin, buffering agents, quinone derivatives, hydrazine hydrates and its derivatives, general class UV stabilizers, glycols and its derivatives and mixtures thereof.

62. The composition as claimed in claim 61, wherein said stabilizer is epoxidized soybean oil.

63. The composition as claimed in claim 53, wherein said inert carrier is selected from colloidal silica, precipitated silica, kaolin, clay, china clay and mixtures thereof.

64. The composition as claimed in claim 63, wherein said inert carrier is present in an amount of from about 10% to about 99% and preferably about 15% to about 98% by weight of the composition.

65. A herbicidal composition comprising clodinafop-propargyl in an amount of about 15% by weight of the composition, Cloquintocet mexyl in an amount of about 3.75% by weight of the composition, metsulfuron methyl in an amount of about 1% by weight of the composition, a dispersing agent in an amount of about 4% by weight of the composition, a wetting/dispersing agent in an amount of about 17.5% by weight of the composition, a stabilizer in an amount of about 4% by weight of the composition, a hydrophobic inert material in an amount of about 8% by weight of the composition and an inert carrier in an amount of about 46.75% by weight of the composition wherein said metsulfuron methyl is provided in a particulate form having a substantially homogenous coating of said hydrophobic inert material.

66. The herbicidal composition as claimed in claim 65, wherein said dispersing agent is sulphated poly aryl alkyl ethoxylate ammonium salt.

67. The herbicidal composition as claimed in claim 65, wherein said wetting/dispersing agent comprises fatty oil ethoxylate or castor oil ethoxylate 40 mole in an amount of about 1.5% by weight of the composition and ethoxylated alkyl phenol in an amount of about 16% by weight of the composition.

68. The herbicidal composition as claimed in claim 65, wherein said hydrophobic inert material is selected from hydrophobic modified silicon dioxide, hydrophobic silica powder and polyvinyl pyrrolidone K-30.

69. The herbicidal composition as claimed in claim 65, wherein said inert carrier is selected from colloidal silica and precipitated silica.

70. A process for the preparation of a herbicidal composition, said process comprising:
(a) grinding metsulfuron methyl to a predetermined particle size;
(b) mixing said ground metsulfuron methyl particles with a hydrophobic inert material to obtain homogenously coated particles of metsulfuron methyl;
(c) melting clodinafop-propargyl with cloquintocet mexyl in predetermined quantities;
(d) adding the melted product of steps (c) to at least one of the excipients selected from the group comprising dispersing agents, wetting agents and stabilizers;
(e) spraying the hot clodinafop liquid mixture obtained in the step (f), over inert carriers;
(f) mixing a predetermined quantity of homogenous coated particles of metsulfuron methyl and Clodinafop pre-mix in a suitable mixing equipment.

71. The process as claimed in claim 70, wherein the product of step (d) is heated to obtain a homogenous clodinafop liquid comprising Clodinafop-propargyl, being substantially free of solid particles and is optionally maintained at temperature of about 35 to about 80° C.

72. The process as claimed in claim 71 comprising mixing the product of step (e) for an additional predetermined amount of time to obtain clodinafop pre-mix in a free flowing powder form before mixing the same with homogenous coated particles of metsulfuron methyl.
